(19) United States
(12) Patent Application Publication
(10) Pub. No.: US 2013/0064352 A1
(43) Pub. Date: Mar. 14, 2013

(54) X-RAY WAVEGUIDE, PROCESS OF PRODUCING X-RAY WAVEGUIDE, AND X-RAY GUIDING SYSTEM

(71) Applicants: Wataru Kubo, Inagi-shi (JP); Kohei Okamoto, Yokohama-shi (JP); Atsushi Komoto, Moriya-shi (JP); Hirokatsu Miyata, Hadano-shi (JP); Takashi Noma, Hadano-shi (JP); Shin Kitamura, Machida-shi (JP); Masahiko Takahashi, Hachioji-shi (JP)

(72) Inventors: Wataru Kubo, Inagi-shi (JP); Kohei Okamoto, Yokohama-shi (JP); Atsushi Komoto, Moriya-shi (JP); Hirokatsu Miyata, Hadano-shi (JP); Takashi Noma, Hadano-shi (JP); Shin Kitamura, Machida-shi (JP); Masahiko Takahashi, Hachioji-shi (JP)

(73) Assignee: CANON KABUSHIKI KAISHA, Tokyo (JP)

(21) Appl. No.: 13/603,733

(22) Filed: Sep. 5, 2012

(30) Foreign Application Priority Data
Sep. 9, 2011 (JP) 2011-197251
Sep. 9, 2011 (JP) 2011-197252
Sep. 9, 2011 (JP) 2011-197253

(51) Int. Cl. G21K 1/00; B05D 5/06

(52) U.S. Cl. 378/145; 427/163.2

(57) ABSTRACT

An X-ray waveguide, for guiding X-rays having a wavelength of 1 pm or more and 100 nm or less, includes: a core and a cladding. The core has a periodic structure composed of a plurality of materials each having a different real part of refractive index in the direction perpendicular to the waveguiding direction. A planarizing layer is disposed between the core and the cladding. The critical angle for total reflection of the X-rays at the interface between the planarizing layer and the cladding is larger than the Bragg angle of the periodic structure of the core.

### BACKGROUND OF THE INVENTION

1. Field of the Invention

The present invention generally relates to waveguides for the generation or use of electromagnetic wave within the X-ray spectrum, and more in particular it relates to an X-ray waveguide and an X-ray guiding system for guiding X-rays.

2. Description of the Related Art

X-rays are widely used in the fields of, for example, medical treatment, non-destructive inspection, and crystal structure analysis. The difference in refractive index of electromagnetic waves having a wavelength of several tens nanometers or less, such as X-rays, at the interface between different materials is small, e.g., about 10⁻⁵ or less. In control of such electromagnetic waves, therefore, a large-sized spatial optical system is used. Though the large-sized spatial optical system is the present mainstream, in order to reduce the size and to enhance the performance of the optical system, X-ray waveguides that confine electromagnetic waves in thin films or multi-layer films and allow waves to propagate therein have been studied, recently. A waveguide is a structure that confines and directs wave propagation. Physical Review B, Vol. 62, p. 16939, (2000) discloses an X-ray waveguide having a multi-layer film of nickel and carbon.

This document describes an X-ray waveguide composed of a cladding made of nickel and a core made of carbon. This X-ray waveguide confines and guides an X-ray by total reflection at the interface between the carbon layer and the nickel layer, and a plurality of the waveguides are stacked and function as a layered product. Accordingly, the layered product can guide a larger quantity of X-rays compared to a waveguide composed of a single set of a pair of cladding layers and a core disposed therebetween (hereinafter, referred to as “monolayer waveguide”).

In the X-ray waveguide as the layered product having the above-mentioned configuration, however, each (a set of a pair of cladding layers and a core disposed therebetween) of the stacked waveguides independently functions as a single monolayer waveguide. Consequently, advantages of a monolayer waveguide, i.e., a uniform phase of emitted X-ray as a whole and effects of concentrating light and of inhibiting emission, are decreased.

### SUMMARY OF THE INVENTION

One aspect of the present invention provides an X-ray waveguide capable of guiding X-rays with a high propagation efficiency and with a uniform phase by enhancing the effect of confining X-ray waves to the core by a novel cladding structure.

According to at least one exemplary embodiment, an X-ray waveguide includes a core having a periodic structure composed of a plurality of materials each having a different real part of refractive index in the direction perpendicular to the waveguiding direction, a cladding having a real part of refractive index lower than that of the core, and a planarizing layer disposed between the core and the cladding. The critical angle for total reflection at the interface between the planarizing layer and the cladding is larger than the Bragg angle of the periodic structure of the core.

According to another exemplary embodiment, an X-ray waveguide for guiding X-rays having a wavelength of 1 pm or more and 100 nm or less, includes a core and a cladding. The core has a periodic structure composed of a plurality of materials each having a different real part of refractive index in the direction perpendicular to the waveguiding direction. A planarizing layer is disposed between the core and the cladding, wherein the critical angle for total reflection at the interface between the planarizing layer and the cladding is larger than the Bragg angle of the periodic structure of the core.

According to yet a further exemplary embodiment, an X-ray waveguide for guiding X-rays includes a core having a periodic structure composed of a plurality of materials each having a different real part of refractive index in the direction perpendicular to the waveguiding direction, a cladding having a real part of refractive index lower than that of the core, and a planarizing layer disposed between the core and the cladding. The core and the planarizing layer are in contact with the cladding, wherein the critical angles for total reflection at the interfaces between the cladding and the planarizing layer and between the cladding and the core are both larger than the Bragg angle of the periodic structure of the core.

According to still another exemplary embodiment, an X-ray guiding system including an X-ray waveguide for guiding X-rays, and an X-ray source emitting X-rays having a wavelength of 1 pm or more and 100 nm or less such that X-rays are incident on the X-ray waveguide. The X-ray waveguide includes a core, a cladding, and a planarizing layer disposed between the core and the cladding, wherein the core has a periodic structure composed of a plurality of materials each having a different real part of refractive index in the direction perpendicular to the waveguiding direction, and the critical angle for total reflection of the incident X-ray at the interface between the planarizing layer and the cladding is larger than the Bragg angle of the periodic structure of the core.

Another aspect of the present invention relates to a process of producing an X-ray waveguide. According to at least one exemplary embodiment, the process includes the steps of forming a planarizing layer on a surface of a core having a periodic structure composed of a plurality of materials each having a different real part of refractive index in the direction perpendicular to the waveguiding direction, and forming a cladding on the planarizing layer.

Further features and advantages of the present invention will become apparent from the following detailed description of the exemplary embodiments with reference to the attached drawings.

### BRIEF DESCRIPTION OF THE DRAWINGS

FIG. 1 is a conceptual diagram of an X-ray waveguide according to an embodiment.

FIG. 2 is a conceptual diagram of the X-ray waveguide.

FIG. 3 is a conceptual diagram of an effective propagation angle θ.

FIG. 4 is a view schematically illustrating the X-ray waveguides produced in Examples 1 to 5.

FIG. 5 is a graph showing dependency of reflectance on the surface roughness at the interface between a silicon oxide film and a tungsten film.

FIG. 6 is a view illustrating a planarizing layer of an X-ray waveguide according to an embodiment.

FIGS. 7A to 7F are diagrams showing the processes of producing X-ray waveguides in Examples 6 to 9.

FIGS. 8A to 8E are diagrams showing the process of producing an X-ray waveguide in Example 11.

FIGS. 9A to 9F are diagrams showing the process of producing an X-ray waveguide in Example 10.

FIGS. 10A to 10F are diagrams showing the process of producing an X-ray waveguide in Example 12.

FIGS. 11A to 11F are diagrams showing the process of producing an X-ray waveguide in Example 13.

FIGS. 12A to 12F are diagrams showing the process of producing an X-ray waveguide in Example 14.

### DESCRIPTION OF THE EMBODIMENTS

An X-ray waveguide according to an embodiment will be described in detail.

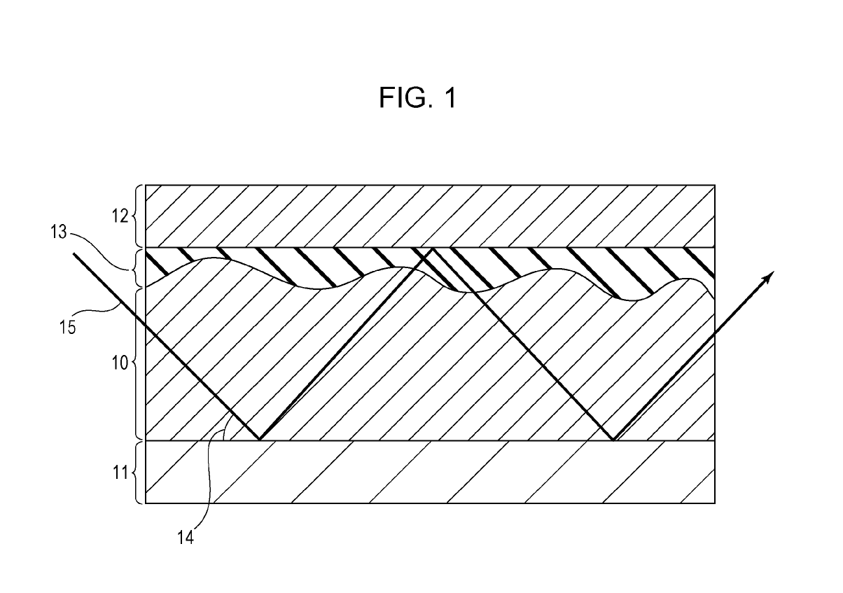

FIG. 1 is a conceptual diagram of an X-ray waveguide according to an exemplary embodiment. In FIG. 1, a core 10 having a periodic structure composed of a plurality of materials each having a different real part of refractive index is disposed between cladding layers 11 and 12 for confining an X-ray 15 in the core 10. A planarizing layer 13 is disposed between the core 10 and the cladding 12. The planarizing layer 13 introduced between the core 10 and the cladding 12 provides the X-ray waveguide of the embodiment with a flat interface between the planarizing layer and the cladding. As a result, an X-ray 15 incident on this X-ray waveguide at a predetermined incident angle 14 is effectively confined by the interface of the planarizing layer and the cladding. Consequently, the X-ray waveguide of the embodiment can guide the X-ray with a high propagation efficiency. FIG. 1 is a schematic view, and the roughness of the core surface is drawn in an exaggerated manner for the reader's ease of understanding. An actual incident angle of the X-ray may also be small, such as 1° or less.

(1) X-ray, (2) X-ray waveguide, (3) core, (4) cladding, and (5) planarizing layer of the X-ray waveguide according to the embodiment will be respectively described below.

### (1) X-Ray

The X-ray guided by the X-ray waveguide of the embodiment will be described. In the present invention, the term “X-ray” generally refers to an electromagnetic wave having a wavelength band in which the real part of refractive index of a material is 1 or less. Specifically, the X-ray described herein refer to an electromagnetic wave having a wavelength of 1×10⁻¹² m (pm) or more, and 100×10⁻⁹ m (nm) or less in which extreme ultra-violet (EUV) light is included. Throughout the specification, the term “electromagnetic wave” may be used as the same meaning as the term “X-ray” described above.

The refractive index (or index of refraction) n of a substance (optical medium) is a number that describes how light, or any other radiation, propagates through that medium. Since the frequency of electromagnetic waves having a short wavelength is very high, the electrons of outer shell of the atoms in the substance cannot respond to such high frequency. Therefore, for X-rays, the refractive index of a medium is slightly less than one, i.e., n=1−δ−iβ. The real part of refractive index of the material for an X-ray is smaller than 1, unlike the frequency band of electromagnetic waves (visible light or infrared light) having a longer wavelength than that of ultraviolet light. The refractive index n of a material for such an X-ray is generally represented using a shifted amount δ from 1 of the real number part and an amount β′ of the imaginary number part related to absorption, as represented by the following Expression (1):

n=1−δ−iβ′=n′−iβ′ (1)

The shifted amount δ is proportional to the electron density ρₑ of a material. The real part of refractive index decreases with an increase in electron density of the material. The real part of refractive index n′ is represented by 1−δ. Furthermore, the electron density ρₑ is proportional to the atomic density ρₐ and the atomic number Z. Thus, the refractive index of a material for an X-ray is represented by a complex number. Throughout the specification, the real part is referred to as the real part of refractive index, and the imaginary part is referred to as the imaginary part refractive index. For example, the real part of refractive index of an X-ray is the maximum when it propagates in vacuum, and under a general environment, the real part of refractive index in the air is the highest compared with those in almost all materials other than gaseous materials. Throughout the specification, the term “material” encompasses both air and vacuum. Accordingly, a mesostructured material or a mesoporous material has a portion having a different refractive index due to the air or vacuum even if the material is constituted of a single raw material, and is also defined to be constituted of a plurality of materials.

### (2) X-Ray Waveguide

In accordance with at least one exemplary embodiment, an X-ray waveguide guides an X-ray by confining the X-ray in a core by total internal reflection at the interface between the cladding and the core. The core has a periodic structure composed of a plurality of materials, each material having a different real part of refractive index, and thereby the waveguide shows a periodicity-resonant waveguide mode described below. If the interface between the core and the cladding is highly rough, the efficiency of confining an X-ray in the core is low. Consequently, the propagation efficiency of the X-ray is low. In order to increase the efficiency of confining an X-ray by the total reflection, the X-ray waveguide disclosed herein has a planarizing layer between the core and the cladding.

Before describing the X-ray waveguide having a planarizing layer, a basic principle of the X-ray waveguide showing a periodicity-resonant waveguide mode will be described. In order to assist understanding of the principle, an X-ray waveguide having an interface between an ideal (smooth) core and a cladding (not having a planarizing layer) will be described.

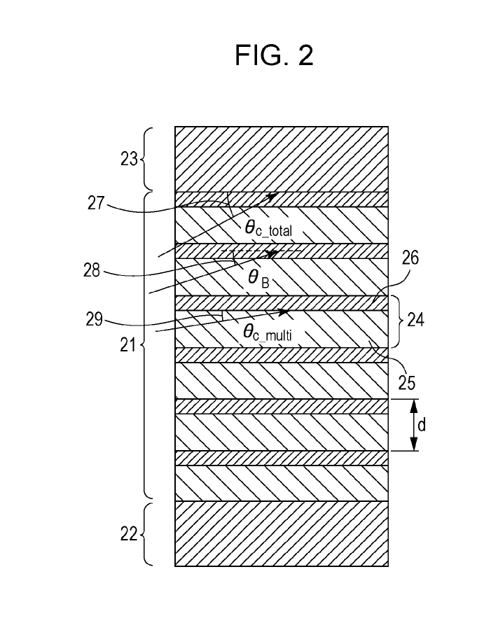

The X-ray waveguide showing a periodicity-resonant waveguide mode forms the guided wave mode by confining an X-ray in the core having a periodic structure through total reflection at the interface between the core and the cladding and allowing the X-ray to propagate. In this waveguide, the critical angle for total reflection at the interface between the core and the cladding is larger than the Bragg angle resulted from the periodicity of the periodic structure of the core. FIG. 2 is a conceptual diagram of an X-ray waveguide without a planarizing layer. In this X-ray waveguide, a core 21 is disposed between a cladding 22 and a cladding 23. The core 21 is constituted of stacked structure units 24 each including a layer 25 of a material having a high real part of refractive index and a layer 26 of a material having a low real part of refractive index. The core 21 of the X-ray waveguide of FIG. 2 may have any of one- to three-dimensional periodic structures. Here, in order to make understanding easier, a one-dimensional periodic structure, such as a multi-layer film, is used for the description. In FIG. 2, the reference number 27 denotes the critical angle for total internal reflection at the interface between the cladding 23 and the core 21, the reference number 28 denotes the Bragg angle, and the reference number 29 denotes the critical angle for total reflection at the interface of materials in the stacked structure unit.

FIG. 2 shows examples of the critical angle for total reflection θ_{c-total} at the interface between the cladding and the core, critical angle for total reflection θ_{c-multi} at the interface between the layers constituting the basic structure of a multi-layer film, and the Bragg angle θ_{B} resulted from the periodicity of the multi-layer film (periodic structure of the core). Throughout the specification, these angles are expressed by assuming that the direction parallel to the surface of the film is 0°. In FIG. 2, the arrows show the traveling direction of an X-ray; that is, the waveguiding direction.

At the interface between the cladding and the core, when the real part of refractive index n_{clad} of the material on the cladding side and the real part of refractive index n_{core} of the material on the core side has a relationship: n_{clad}<n_{corer} the critical angle for total reflection θ_{c-total} (°) from the direction parallel to the film surface is expressed by the following Expression (2):

$${θ}_{c \text{-} total} = \frac{180}{π} arccos ( \frac{{n}_{clad}}{{n}_{core}} ) \qquad ( 2 )$$

Regardless of the presence or absence of multiple diffraction in the core, the Bragg angle θ_{B} (°) is based on the Bragg equation [mλ=2d sin θ], and in the present disclosure it can be roughly defined using the period d of the one-dimensional periodic structure of the core and the average real part of refractive index n_{avg} of the periodic structure of the core by the following Expression (3):

$${θ}_{B} \approx \frac{180}{π} arcsin ( \frac{1}{{n}_{avg}} m \frac{λ}{2 d} ) \qquad ( 3 )$$

where m denotes a constant, and λ denotes the wavelength of the X-ray propagating through the core.

The physical property parameters of the materials constituting the X-ray waveguide, the structural parameters of the waveguide, and the wavelength of the X-ray are designed so as to satisfy the following Expression (4):

θ_{B}<θ_{c-total} (4)

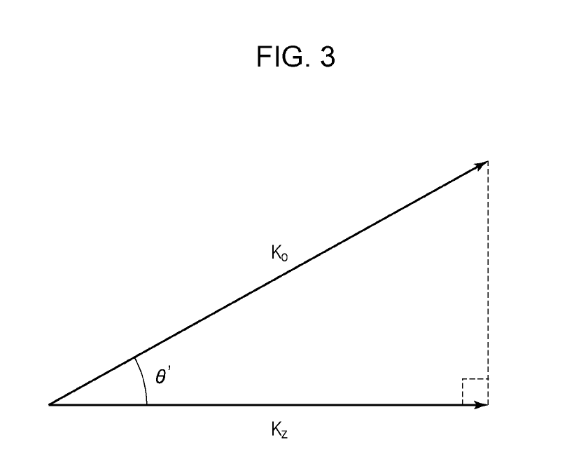

By satisfying Expression (4), a guided wave mode having an effective propagation angle, for example, being close to the Bragg angle of the periodic structure of the core can be constantly confined in the core by the cladding to contribute to propagation of an X-ray. Throughout the specification, the effective propagation angle θ′ (°) is expressed by the following Expression (5) using the wave vector (propagation constant) k_{z} in the propagation direction of the guided wave mode and the wave vector k₀ in vacuum. Due to the conditions of continuity, since the k_{z} is constant at the interface of each layer, as shown in FIG. 3, the effective propagation angle θ′ (°) is an angle defined between the propagation constant k_{z} of the fundamental wave of a guided wave mode and the wave vector k₀ in vacuum and denotes the angle in which the fundamental waves of the guided wave mode propagate in vacuum. This can be thought to approximately denote the propagation angle of the fundamental waves of the guided wave mode in the core and is accordingly used in the descriptions below.

$${θ}^{′} = \frac{180}{π} arccos ( \frac{{k}_{z}}{{k}_{o}} ) \qquad ( 5 )$$

Here, the periodic structure of the core is supposed to be a multi-layer film where a plurality films of materials each having a different real part of refractive index are periodically stacked. In this structure, a critical angle for total reflection due to the difference in real part of refractive index exists at the interface between adjacent films. This angle is represented by θ_{c-multi} (°).

θ_{c-multi}<θ_{B} (6)

When the Expression (6) is satisfied and the critical angle for total reflection in the multi-layer film is smaller than the Bragg angle resulted from the periodicity of the multi-layer film, an X-ray incident on the interface in the multi-layer film at an angle not smaller than the Bragg angle does not cause total reflection, but causes partial reflection or refraction. The multi-layer film is composed of a plurality of films that each have a different real part of refractive index and are periodically stacked, and therefore has a plurality of interfaces in the stack direction. Consequently, an X-ray inside the multi-layer film repeats reflection or refraction at these interactions, which causes multiple interference. As a result, an X-ray that can resonate with the periodic structure of the multi-layer film, i.e., a propagation mode that can exist inside the multi-layer film, is formed, resulting in formation of a guided wave mode in the core of the X-ray waveguide. This is called a periodicity-resonant waveguide mode.

The periodicity-resonant waveguide mode has its own effective propagation angle. The effective propagation angle of the periodicity-resonant waveguide mode having a minimum effective propagation angle appears near the Bragg angle of the multi-layer film. Throughout the specification, the term “periodicity-resonant waveguide mode” refers to a mode that resonates with the periodicity of the periodic structure. This corresponds to the propagation mode satisfying the lowest order band when the multi-layer film is supposed to be one-dimensional photonic crystals having an infinite periodic number. This propagation mode is confined by the total reflection at the interface between the cladding and the core.

An actual one-dimensional periodic structure has a limitation in periodic number. Therefore, the photonic band structure thereof shifts from the photonic band structure of a one-dimensional periodic structure having infinite periodicity, but with an increase in periodic number, the characteristics of the guided wave mode approximate to those of a guided wave mode in the photonic band having infinite periodicity. Bragg reflection is caused by an effect of a photonic band gap due to the periodicity, and the Bragg angle providing the Bragg reflection is slightly larger than the effective propagation angle of a periodicity-resonant waveguide mode. In the photonic band structure of a periodic structure, a guided mode that resonates with the periodic structure exists at the photonic band gap end. In the effective propagation angles of guided wave modes when the energy of an X-ray is supposed to be constant, among these guided wave modes, a guided wave mode having a relatively small effective propagation angle is the lowest order periodicity-resonant waveguide mode. In a spatial distribution profile of electric field intensity of a periodicity-resonant waveguide mode, the number of antinodes of the electric field intensity basically coincides with the periodic number of the multi-layer film. The positions of antinodes of a higher order periodicity-resonant waveguide mode having an effective propagation angle corresponding to a higher order Bragg angle are basically natural-number (2 or more) multiples of the periodic number.

In the multi-layer film having a limitation in periodic number, a guided wave mode having an angle other than the effective propagation angle having a periodicity-resonant waveguide mode as described above can also exist. This is not the periodicity-resonant waveguide mode, but is a guided wave mode existing when the entire multi-layer film serving as the core is supposed as a uniform medium having a uniformized real part of refractive index, and the characteristics of such a guided wave mode are basically less affected by the periodicity of the multi-layer film. In contrast, in the periodicity-resonant waveguide mode realized by this X-ray waveguide configuration, an increase in periodic number of the periodic structure further concentrates electric field in the center of the core as a multi-layer film, decreases leakage to the cladding, and reduces a loss in propagation of an X-ray. The envelope curve of an electric field intensity distribution has a shape where the intensity is high in the center of the core. Thus, the loss in electric field due to leakage to the cladding is further reduced. Furthermore, the phase of the periodicity-resonant waveguide mode used in the X-ray waveguide is uniformized in the direction of higher periodicity, i.e., in the direction perpendicular to the interface between the cladding and the core and also perpendicular to the wave-guiding direction, and spatial coherence can be provided. Here, uniformization in phase of a guided wave mode means not only that the phase difference of an electromagnetic field in a plane perpendicular to the wave-guiding direction is 0, but also that the phase difference of the electromagnetic field periodically varies between −π and +π, corresponding to the spatial refractive index distribution of the periodic structure. In this periodicity-resonant waveguide mode, the phase of an electric field varies between −π and +π with the same period as that of the periodic structure in the direction perpendicular to the wave-guiding direction.

### (3) Core

In the present invention, the core has a periodic structure composed of a plurality of materials each having a different real part of refractive index. In the present invention, materials each having a different real part of refractive index are, in many cases, two or more materials having different electron densities. The periodic structure may be any of one- to three-dimensional periodic structures, but should have periodicity in a plane perpendicular to the X-ray-guiding direction. Such a periodic structure can also be produced by a known semiconductor-producing process such as photolithography, electron beam lithography, an etching process, lamination, or bonding. For example, in a case of a one-dimensional periodic structure, this periodic structure can be constituted as a multi-layer film. In this case, the multi-layer film can be formed by, for example, alternate vapor deposition or sputtering.

The materials each having a different real part of refractive index forming the core may be not only inorganic or organic solid materials but also the air or vacuum. In addition, a combination of these materials can be used. Examples of the inorganic material include boron, boron compounds, beryllium, carbon, nitrides, oxides, and phosphorus, more specifically, Be, B, C, B₄C, BN, SiC, Si₃N₄, SiN, Al₂O₃, MgO, TiO₂, SiO₂, and P. Use of an inorganic material as a raw material for forming the core makes it possible to form the core by a known established process such as sputtering, vapor deposition, or crystal growth, and can provide a structure having high resistance to heat and external force. Examples of the organic material include polymers and low-molecular compounds, more specifically, various resist materials, polyimides, and vinyl polymers. Use of an organic material can reduce a propagation loss by X-ray absorption. The air and vacuum can further reduce this loss.

In addition, as a raw material for forming the periodic structure, a raw material produced by a self-organizing formation mechanism, which is different from a usual semiconductor-producing process, may be used. A mesostructured film, which is formed by self-assembly of a surfactant, is an example. This mesostructured film can be used as the periodic structure in the present invention. The mesostructured film will be described below.

### (3-1) Mesostructured Film

Porous materials are classified depending on the pore sizes by the International Union of Pure and Applied Chemistry (IUPAC). Porous materials having a pore size of 2 to 50 nm are classified in mesoporous materials. Recently, such mesoporous materials have been actively studied, and a structure where mesopores having a uniform diameter are regularly arranged can be obtained by using a surfactant assembly as a template.

Throughout the specification, the term mesostructured film includes (A) mesoporous film, (B) mesoporous film of which pores are mainly filled with an organic compound, and (C) mesostructured film having a lamella structure. Details thereof will be described below.

### (A) Mesoporous Film

The mesoporous film is formed of a porous material having a pore diameter of 2 to 50 nm. The material for a wall portion can be an oxide, from the viewpoint of manufacturability and constituting a periodic structure of materials each having a different real part of refractive index. Examples of the oxide include silicon oxide, tin oxide, zirconium oxide, titanium oxide, niobium oxide, tantalum oxide, aluminum oxide, tungsten oxide, hafnium oxide, and zinc oxide. These materials all have a real part of refractive index of 0.999997 or less for, for example, an X-ray of 10 keV and can form a periodic structure with a material having a different real part of refractive index such as organic materials (having a real part of refractive index of about 0.999998 for the same X-ray) described below or the air (having a real part of refractive index of about 1 for the same X-ray). The above-mentioned oxides may contain an organic component in the skeleton thereof. The surface of the wall portion may be optionally modified, for example, with hydrophobic molecules for inhibiting water absorption.

The mesoporous film may be produced by any method and, for example, by the following process: A precursor of an inorganic oxide is added to a solution of an amphiphilic material that functions as a template by assembling, a film of the solution is formed, and a reaction of generating an inorganic oxide is allowed to progress. Then, the template molecules are removed to prepare a porous material.

The amphiphilic material is not particularly limited and may be a surfactant. The surfactant may be ionic or nonionic. Examples of the ionic surfactant include halogenated salts of trimethylalkylammonium ions. The alkyl chain can have a chain length of 10 to 22 carbon atoms. Examples of the nonionic surfactant include surfactants having polyethylene glycol as hydrophilic groups, such as polyethylene glycol alkyl ether and block polymers of polyethylene glycol-polypropylene glycol-polyethylene glycol. The alkyl chain of the polyethylene glycol alkyl ether can have a chain length of 10 to 22 carbon atoms. The repeating number of the polyethylene glycol can be 2 to 50 as the carbon number. The structural period can be changed by varying the hydrophobic groups and the hydrophilic groups. In general, the pore diameter can be increased by using larger hydrophobic and hydrophilic groups. In addition to the surfactant, an additive for adjusting the structural period may be used. The additive for adjusting the structural period can be a hydrophobic material. Examples of the hydrophobic material include alkanes and hydrophilic-free aromatic compounds, more specifically, octane.

Examples of the precursor of an inorganic oxide include alkoxides and chlorides of silicon and metallic elements, more specifically, alkoxides and chlorides of Si, Zr, Ti, Nb, Al, Zn, and Sn. Examples of the alkoxide include methoxide, ethoxide, propoxide, and those partially substituted by alkyl groups.

The process of forming a film may be dip coating, spin coating, or a hydrothermal method.

The template molecules may be removed by firing, extraction, ultraviolet irradiation, or ozonization.

(B) Mesoporous Film of which Pores are Mainly Filled with an Organic Compound

The material for the wall portion may be the same as those described in the paragraph (A). The material filling pores are not particularly limited as long as it is mainly an organic compound. The term “mainly” means a volume ratio of 50% or more. Examples of the organic compound include surfactants and materials in which the moiety having a molecular assembly-forming function is linked to a material forming the wall portion or a precursor of the material forming the wall portion. Examples of the surfactant may be the same as those described in the paragraph (A). Examples of the material in which the moiety having a molecular assembly-forming function is linked to a material forming the wall portion or a precursor of the material forming the wall portion include alkoxysilane compounds having alkyl groups and oligosiloxane compounds having alkyl groups. The alkyl chain has a chain length of 10 to 22 carbon atoms.

The inside of the pores may contain water, an organic solvent, a salt, or another substance, optionally or as a consequence resulted from the material or process used. Examples of the organic solvent include alcohols, ethers, and hydrocarbons.

The mesoporous film of which pores are mainly filled with an organic compound may be produced by any method, for example, in the method of producing the mesoporous film described in the paragraph (A), the process before the template-removing step.

### (C) Mesostructured Film Having a Lamella Structure

The mesostructured film of the embodiment may be a mesostructured film having a lamella structure, in addition to mesoporous films (A) and (B). This lamella structure is composed of a material for the wall portion described in the paragraph of mesoporous film (B) and a material contained in the pores described in the paragraph of mesoporous film (B). These two types of raw materials may be optionally linked to each other with a chemical bond in order to obtain desired characteristics. Examples of the compound having a lamella structure in which compounds are linked to each other include trialkoxyalkylsilane.

### (4) Cladding

The X-ray waveguide of the embodiment guides an X-ray by confining the X-ray in the core (and the planarizing layer) by total reflection at the cladding. The cladding is made of a material having a lower real part of refractive index than that of the core. In the region of X-rays, the real part of refractive index decreases with an increase in electron density of a material. Accordingly, the material for the cladding may be a metal having a high density. Specifically, an elementary substance of Os, Ir, Pt, Au, W, Ta, Hg, Ru, Rh, Pd, Pb, or Mo or a material containing such an element can be used. The cladding of these materials can be formed by, for example, sputtering or vapor deposition. The thickness of the cladding varies depending on the material and is required to be sufficiently thick to confine an X-ray in the core and also to be thin from the viewpoints of cost and manufacturing. The thickness of the cladding can be 1 nm or more and 300 nm or less, particularly, 1 nm or more and 50 nm or less. The cladding may be formed so as to have a film thickness distribution in the X-ray waveguide. For example, in order to enhance incidence through the cladding surface, the transfer efficiency is improved by forming a film with a small thickness in the incidence region, and also forming the film with a large thickness in other regions to enhance the effect of confining an X-ray.

### (5-1) Planarizing Layer

The X-ray waveguide of the embodiment guides an X-ray by confining the X-ray in the core by total reflection at the cladding. On this occasion, an increase in efficiency of the total reflection at the cladding enhances the efficiency of confining the X-ray in the core and thereby increases the propagation efficiency of the X-ray. Total reflection efficiency of an X-ray is highly affected by the roughness of the total reflection interface, and it is known that the efficiency increases with a reduction in roughness of the interface. The present inventors have investigated various configurations of X-ray waveguides and have confirmed that the propagation efficiency is increased by reducing the roughness of the interface between the core and the cladding, in some X-ray waveguides. After various investigations, the inventors have reached a conclusion that a planarizing layer having the following characteristics is suitable.

First, from the viewpoint of effect of planarization, a planarizing layer will be described. The planarizing layer may be made of a material having a low electron density from the viewpoint of the absorption loss of an X-ray. However, when the planarizing layer is made of a material having a relatively low electron density, the effect of planarizing is limited due to damage during formation of a cladding, in some cases. The present inventors have investigated this point and, as a result, have confirmed an increase in propagation efficiency, which is believed to be caused by planarization, when the electron density of the planarizing layer is higher than that of the material having the highest electron density among the materials constituting the core. Accordingly, a material having an electron density equal to or higher than that of the material having the highest electron density among the materials constituting the core can be used as the material for the planarizing layer in the X-ray waveguide of the embodiment. In addition, in light of absorption loss of an X-ray, the material for the planarizing layer in the X-ray waveguide of the embodiment can have an electron density equal to that of the material having the highest electron density among the materials constituting the core.

The physical properties of the material for the planarizing layer are defined by the electron density thereof because of the following reasons. The X-ray waveguide of the embodiment utilizes phenomena, refraction and interference, which are caused by an X-ray at the interface between different materials. The main property of a material that affects the refraction and interference of the X-ray in causing these phenomena is a difference in electron density. In the present invention, therefore, the material of the planarizing layer used in the X-ray waveguide is defined by the electron density thereof. The electron density of a planarizing layer can be determined through measurement of X-ray reflectance and calculation from an observed critical angle for total reflection. The electron density of the material having the highest electron density among the materials constituting the core can be similarly calculated from the critical angle for total reflection of a film made of the material, and is used as the object for comparison.

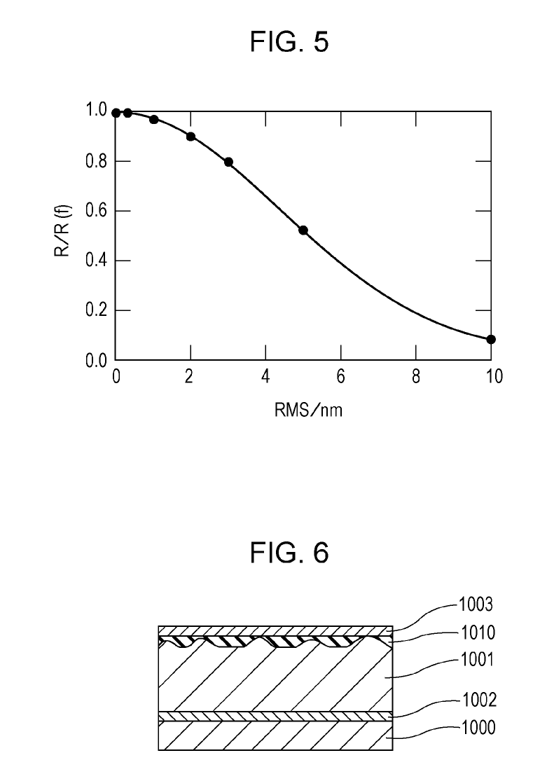

The planarizing layer can have a surface roughness of 5 nm or less, particularly, 3 nm or less, as the root-mean-square value. FIG. 5 shows calculated values of dependency of reflectance on the surface roughness of the interface between silicon oxide and tungsten films when an X-ray is incident on the tungsten interface from the porous silicon oxide film side at an angle of 0.4°. In FIG. 5, the horizontal axis indicates root-mean-square value of the silicon oxide/tungsten interface, and the vertical axis indicates the standardized reflectance provided that the reflectance is 1 when a root-mean-square value at the interface is supposed to be 0. As recognized from FIG. 5, the reflectance increases in a sigmoidal fashion with a reduction in surface roughness. The reflectance is notably increased when the root-mean-square value is 5 nm or less and is further increased at a root-mean-square value of 3 nm or less.

Secondly, the planarizing layer is investigated from the viewpoint of influence of refractive index. The X-ray waveguide of the embodiment guides an X-ray by confining the X-ray in the core (and the planarizing layer) by total reflection at the interface between the planarizing layer and the cladding. On this occasion, in order to cause total reflection at the interface between the planarizing layer and the cladding, the real part of refractive index of the planarizing layer is required to be higher than that of the cladding. In the electromagnetic waves in the region of X-rays, the real part of refractive index of a material decreases with an increase in electron density of the material. Accordingly, the material used for the planarizing layer in the X-ray waveguide of the embodiment is required to have a lower electron density than that of the cladding.

The X-ray waveguide of the embodiment can show a periodicity-resonant waveguide mode. In order to show the periodicity-resonant waveguide mode, the critical angle for total reflection at the interface between the planarizing layer and the cladding is selected to be larger than the Bragg angle resulted from the periodicity of the core.

The material for the planarizing layer may be any material that satisfies the requirement that the electron density thereof is equal to or higher than that of the material having the highest electron density among the materials constituting the core. Examples of the material for the planarizing layer include inorganic materials, organic materials, and inorganic/organic composite materials. Examples of the inorganic material include oxides, light metals, and carbon. Among these inorganic materials, the oxides have resistance to cladding formation, and also the electron densities thereof are not high. Therefore, the oxides can advantageously reduce the absorption loss. Specific examples of the oxide include oxides of Si, Al, Ti, Zn, Nb, Zr, and Sn. In particular, oxides of Si and Al can be used. Examples of the organic material include polymer materials. Examples of the inorganic/organic composite material include those where inorganic particles are dispersed in organic materials and those where organic molecules are incorporated in skeletons of inorganic materials. Examples of the former include those where oxide particles are dispersed in polymers, and examples of the latter include organosilicon compounds. These materials may be used as porous materials from the viewpoint of controlling electron density and other viewpoints. The planarizing layer can be formed by a method that is usually used for forming a film of the material used in the planarizing layer. For example, a film of an inorganic material can be formed by sputtering, vapor deposition, or a sol-gel method; a film of an organic material can be formed by application using a solution prepared by dissolving the organic material in a solvent or vapor deposition; and a film of a composite material can be formed by application using a solution prepared by dissolving the composite material in a solvent or a sol-gel method.

The X-ray waveguide of the embodiment can increase the total reflection efficiency at the cladding by introducing a planarizing layer effective for planarization and can guide an X-ray with a high propagation efficiency by increasing the efficiency of confining the X-ray in the core (or the planarizing layer). As a result, the present invention can provide a waveguide that can effectively utilize characteristics of a periodicity-resonant waveguide mode: a reduction in loss of propagation through concentration of an electric field in the center of the core and possession of spatial coherence.

An X-ray guiding system of the embodiment will now be described. The X-ray guiding system of the embodiment includes at least an X-ray source and an X-ray waveguide. The X-ray source emits an X-ray of 1 pm or more and 100 nm or less. The X-ray emitted from the X-ray source may have a single wavelength or a band of wavelengths. The X-ray emitted from the X-ray source is allowed to be incident on the X-ray waveguide. The waveguide of the X-ray guiding system of the embodiment includes a core and a cladding, and the core has a periodic structure where a plurality of materials each having a different real part of refractive index are periodically arranged in the direction perpendicular to the X-ray guiding direction of the core. The X-ray waveguide has a planarizing layer between the core and the cladding. The critical angle for total reflection of the incident X-ray at the interface between the planarizing layer and the cladding is larger than the Bragg angle resulted from the periodicity of the core. The electron density of the planarizing layer is equal to or higher than that of the material having the highest electron density among the materials constituting the core and is lower than that of the cladding. The above descriptions for the X-ray waveguide apply to the X-ray waveguide of the X-ray guiding system of the embodiment.

### (5-2) Planarizing Layer

The planarizing layer may have a configuration shown below, which is different from that of the planarizing layer in the paragraph (5-1).

The X-ray waveguide in this embodiment guides an X-ray by confining the X-ray in the core by total reflection at the interface between the core (and planarizing layer) and the cladding. On this occasion, an increase in efficiency of the total reflection at the cladding interface enhances the efficiency of confining the X-ray in the core and thereby increases the propagation efficiency of the X-ray. Total reflection efficiency of an X-ray is highly affected by the roughness of the total reflection interface, and the efficiency increases with a reduction in roughness of the interface. The present inventors have investigated various configurations of X-ray waveguides and have confirmed that the propagation efficiency is increased by reducing the roughness of the interface between the core and the cladding, in some X-ray waveguides.

In the X-ray waveguide of the embodiment, a “planarizing layer” is introduced between the core and the cladding for planarization to reduce the roughness of the interface. After various investigations, the inventors have reached a conclusion that a planarizing layer satisfying the following requirements is suitable.

FIG. 6 is a view illustrating a planarizing layer of the embodiment.

First, the planarizing layer is investigated from the viewpoint of refractive index. In light of the principle of the X-ray waveguide as described in paragraph (2), the planarizing layer introduced for reducing the roughness of the interface should show the same properties to an X-ray as the core does. The X-ray waveguide of the embodiment utilizes phenomena, refraction and interference, which are caused by an X-ray at the interface between different materials. The difference in X-ray guiding characteristics in causing these phenomena is mainly a difference in electron density. Accordingly, the electron density of the planarizing layer should be close to that of the materials constituting the core. The electron density is mainly determined by the atomic number of the material constituting the planarizing layer and the atomic density of the planarizing layer.

Ideally, the planarizing layer is of the same medium as that of the core, but in such a case, the flatness may be insufficient. If priority is placed on the flatness, the media that are not recognized to be the same due to a difference in electron density are used in some cases. In such a case, the volume of the planarizing layer to be introduced into the X-ray waveguide should be as small as possible compared with the volume of the core.

Secondly, the planarizing layer is investigated from the viewpoint of effect of planarization. The method of forming the planarizing layer and the material for the planarizing layer are selected to be [1] suitable for reducing the roughness of the core surface or to be [2] suitable for planarization treatment after the formation of the planarizing layer. In the planarization treatment in the requirement [2], the resulting planarizing layer is planarized for the purposes to reduce the roughness of the core surface by formation of the planarizing layer and to reduce the volume of the planarizing layer as much as possible, as described above, after the formation of the planarizing layer.

The method of forming a planarizing layer satisfying the requirement [1] can form a planarizing layer by application and drying a solution system such as spin-on glass (hereinafter, referred to SOG) and has an effect of planarizing the roughness of the base through fluidization during drying condensation. In the planarization treatment in the requirement [2], when the planarizing layer is partially removed by chemical etching or physical polishing, if either the planarizing layer or the core is hardly removed, roughness is caused during the removing step. Accordingly, the X-ray guiding characteristics of the planarizing layer and the core should be the same as much as possible. The qualities (constitutional atoms, chemical bonding conditions of the atoms, and atomic density) of the materials for the planarizing layer and the core should be the same as much as possible.

The planarizing layer may be formed of any material that satisfies the above-mentioned requirements. Examples of the material for the planarizing layer include inorganic materials, organic materials, and inorganic/organic composite materials. Examples of the inorganic material include oxides, light metals, and carbon. Among these inorganic materials, the oxides can easily form a strong layer by application and drying and show high adherence. Specific examples of the oxide include oxides of Si, Al, Ti, Zn, Nb, Zr, and Sn. In particular, oxides of Si and Al can be used.

Examples of the inorganic/organic composite material include those where inorganic particles are dispersed in organic materials and those where organic molecules are incorporated in skeletons of inorganic materials. Examples of the former include those where oxide particles are dispersed in polymers, and examples of the latter include organosilicon compounds.

These materials described above may be used as porous media from the viewpoint of controlling electron density and other viewpoints.

The planarizing layer can be formed as follows: for example, a film of an inorganic material can be formed by sputtering, chemical vapor deposition (CVD), vapor deposition, or application using a solution system (by a sol-gel method); a film of an organic material can be formed by application using a solution system or vapor deposition; and a film of a composite material can be formed by application using a solution system or a sol-gel method.

As a method of forming the planarizing layer particularly used in an aspect of the present invention, a method of forming a Si oxide through application using a solution system will be described in detail. As an application solution, for example, a commercially available material generally called spin-on glass (SOG) is used after dilution with an appropriate solvent so as to form a planarizing layer with a desired thickness. Examples of the precursor of the Si oxide in the SOG material include inorganic materials such as tetraalkoxysilane and perhydrosilazane and also inorganic/organic composite materials such as alkyl alkoxy silane, siloxane, and organosilsesquioxane. As the dilution solvent, a solvent that is used in various SOG materials, such as alcohols, ethers, and xylenes, may be appropriately selected.

The above-mentioned SOG material is applied onto a core formed by, for example, spin coating, dip coating, or spraying and is dried to form a Si oxide. The SOG material in a liquid form flows into the concave portions of the rough surface of the core and thereby planarizes the surface. The method of drying is appropriately selected, such as drying at ordinary temperature and ordinary pressure, heating, firing, or drying in an inert gas atmosphere or reduced pressure in some cases (e.g., in the case of gently performing hydrolysis condensation reaction of a precursor by controlling the amount of water).

Here, Si oxide has been described in detail as an example. As described above, the material is not limited to Si oxide, and other materials can be formed by similar methods.

Subsequently, the thus formed planarizing layer is further subjected to a step for planarization. Specifically, the planarizing layer is partially removed (which means that the thickness of the layer is reduced by removing a part of the resulting layer) by chemical etching or physical polishing. As the method, liquid phase etching, plasma treatment etching, mechanical polishing with a polishing agent, or chemical mechanical polishing (CMP), where a chemical solution that chemically reacts with the planarizing layer is used in combination with a polishing agent is used, can be employed.

The surface roughness of the core or the planarizing layer at the interface with the cladding can be 5 nm or less, particularly, 3 nm or less, as the root-mean-square value. The ratio of the surface area of the cladding being in contact with the core to the total surface area of the cladding being in contact with the planarizing layer and the core can be 30% or more and 95% or less, particularly, 60% or more and 95% or less. If the ratio of the surface area of the cladding being in contact with the core is less than 30%, the surface area of the planarizing layer being in contact with the core is increased with an increase in the surface area of the cladding being in contact with the planarizing layer, resulting in an increase in loss of propagation of a resonant guided wave mode. If the ratio of the surface area of the cladding being in contact with the core is higher than 95%, planarization of the interface between the planarizing layer and the cladding is difficult. Each surface area can be evaluated by observing the surface at the stage before arrangement of the cladding, i.e., in the state that the core and the planarizing layer are exposed, with a scanning electron microscope (SEM). The surface area of each of the core and the planarizing layer can be determined from the contrast difference of the core region and the planarizing layer region in the resulting SEM image. It is assumed that the entire core region and planarizing layer region exposed in this observation stage are brought into contact with the cladding.

In the X-ray waveguide of the embodiment, the total reflection efficiency at the cladding interface can be increased by planarizing the interface between the core and the cladding using the planarizing layer, and the efficiency of confining to the core (and the planarizing layer) can be increased. As a result, the X-ray waveguide of the embodiment can guide an X-ray with a high propagation efficiency. In addition, the X-ray waveguide of the embodiment can reduce a loss in propagation by concentrating an electric field in the center of the core and can guide an X-ray having spatial coherence, which are characteristics of a periodicity-resonant waveguide mode.

The X-ray guiding system of the embodiment will now be described. The X-ray guiding system of the embodiment includes at least an X-ray source and an X-ray waveguide. The X-ray source emits an X-ray of 1 pm or more and 100 nm or less. The X-ray emitted from the X-ray source may have a single wavelength or a band of wavelengths. The X-ray emitted from the X-ray source is allowed to be incident on the X-ray waveguide. The waveguide of the X-ray guiding system of the embodiment includes of a core and a cladding, and the core has a periodic structure where a plurality of materials each having a different real part of refractive index are periodically arranged in the direction perpendicular to the X-ray guiding direction of the core. The X-ray waveguide has a planarizing layer between the core and the cladding. The core and the planarizing layer are in contact with the cladding. The critical angle for total reflection to the incident X-ray at the interface between the planarizing layer and the cladding is larger than the Bragg angle resulted from the periodicity of the core. The above descriptions for the X-ray waveguide apply to the X-ray waveguide of the X-ray guiding system of the embodiment.

### (6) Process of Producing Planarizing Layer

### (6-1) Step of Forming Planarizing Layer

The planarizing layer formed in an aspect of the present invention will be described. The X-ray waveguide produced in an aspect of the present invention guides an X-ray by confining the X-ray in the core by total reflection at the cladding interface. The efficiency of confining the X-ray in the core is increased by reducing the scattering loss in the total reflection at the cladding, and thereby the propagation efficiency of the X-ray is increased. Total reflection of an X-ray is highly affected by the roughness of the total reflection interface, and the scattering loss decreases with a reduction in roughness of the interface. The present inventors have investigated various configurations of X-ray waveguides and have confirmed that the propagation efficiency is increased by reducing the roughness of the interface between the core and the cladding, in some X-ray waveguides.

In the process of producing the X-ray waveguide in an aspect of the present invention, a “planarizing layer” is introduced between the core and the cladding for planarization to reduce the roughness of the interface. After various investigations, the inventors have reached a conclusion that a planarizing layer having the following characteristics is suitable.

First, the planarizing layer is investigated from the viewpoint of refractive index. The planarizing layer introduced for reducing the roughness of the interface should have X-ray guiding characteristics that are the same as or similar to those of the core in light of the principle of the X-ray waveguide. The X-ray waveguide produced by the process according to an aspect of the present invention utilizes phenomena, refraction and interference, which are caused by an X-ray at the interface between different materials. In causing these phenomena, the difference in materials that is recognized by an X-ray is believed to be mainly a difference in electron density. The electron density is determined by the atomic number Z of the material constituting the planarizing layer and the atomic density of the planarizing layer. The planarizing layer should have X-ray guiding characteristics that are the same as or similar to those of the core, but the difference in electron density of the planarizing layer and the core may be large in some cases. In such a case, the volume of the planarizing layer finally remaining in the X-ray waveguide should be as small as possible compared with the volume of the core. In the case where the interface between the core and the cladding can be planarized by removing all the planarizing layer, the entire resulting planarizing layer may be removed.

Secondly, the formation and planarization of the planarizing layer is investigated from the viewpoint of effect of planarization. As the material for the planarizing layer, a material that can form the planarizing layer so as to reduce the roughness of the core surface and has suitable physical properties for planarization treatment after the formation of the planarizing layer is selected.

The material for the planarizing layer may be any material having the above-mentioned properties. The material for the planarizing layer may be an inorganic material, organic material, or inorganic/organic composite material, which may be affected by the material constituting the core. Examples of the inorganic material include oxides, light metals, and carbon. Among these inorganic materials, the oxides can easily form a strong layer by application and drying and show high adherence. Specifically, an oxide having the above-mentioned propertied may be selected from oxides of Si, Al, Ti, Zn, Nb, Zr, and Sn. These oxides may be used as porous media. The material for the planarizing layer can have the same qualities as those of the core.

The planarizing layer can be formed as follows: for example, a film of an inorganic material can be formed by sputtering, chemical vapor deposition (CVD), vapor deposition, or application using a solution system (by a sol-gel method); a film of an organic material can be formed by application using a solution system or vapor deposition; and a film of a composite material can be formed by application using a solution system.

As a method of forming the planarizing layer particularly used in an aspect of the present invention, a method of forming a Si oxide through application using a solution system will be described in detail. As an application solution, for example, a commercially available material generally called spin-on glass (SOG) is used after dilution with an appropriate solvent so as to form a planarizing layer with a desired thickness. Examples of the precursor of the Si oxide in the SOG material include inorganic materials such as tetraalkoxysilane and perhydrosilazane and also inorganic/organic composite materials such as alkyl alkoxy silane, siloxane, and organosilsesquioxane. As the dilution solvent, a solvent that is used in various SOG materials, such as an alcohol, ether, or xylene solvent, may be appropriately selected.

The above-mentioned SOG material is applied onto a core formed by, for example, spin coating, dip coating, or spraying and is dried to form a Si oxide. Surface planarization is performed by flowing of the SOG material in a liquid form into the concave portions of the rough surface of the core and fluidization of the SOG material during condensation of the Si precursor in the subsequent drying step. The method of drying is appropriately selected, such as drying at ordinary temperature and ordinary pressure, heating, firing, or drying in an inert gas atmosphere or reduced pressure in some cases (e.g., in the case of gently performing hydrolysis condensation reaction of a precursor by controlling the amount of water).

Here, Si oxide has been described in detail as an example. As described above, the material is not limited to Si oxide, and other materials can be formed by similar methods.

Planarization step after the formation of the planarizing layer will be described. In the process of producing the X-ray waveguide according to an aspect of the present invention, the resulting planarizing layer can be further subjected to a step for planarization. Specifically, the planarizing layer is removed by chemical etching or physical polishing. Examples of the method for planarization include liquid phase etching, plasma treatment etching, mechanical polishing with a polishing agent, and chemical mechanical polishing (CMP) where a chemical solution that chemically reacts with the planarizing layer is used in combination with a polishing agent.

In the planarization step, the planarizing layer formed can be partially or wholly removed. In the case of removing a part of the planarizing layer, the cladding is brought into contact with the planarizing layer (and the core). In the case of removing the entire planarizing layer, the cladding is brought into contact with the core.

The surface roughness of the planarizing layer (or the core) at the interface between the planarizing layer (or the core) and the cladding can be controlled to be 5 nm or less, particularly, 3 nm or less, as the root-mean-square value, in the planarization step. In the case of satisfying these conditions, the propagation loss due to scattering of an X-ray at the interface between the cladding and the planarizing layer or the core can be further reduced, and the adhesion between the cladding and the planarizing layer or the core can be strengthened.

The thus formed planarizing layer can have a thickness in the range of 1 nm to 5 pm, particularly, 3 to 100 nm. Here, the thickness of the planarizing layer refers to the thickness from the material serving as the base to the surface when viewed from the cross-sectional direction in the layer. When the base surface has roughness, the thickness is that from the lowest position.

### (6-2) Step of Forming Cladding

The X-ray waveguide according to an aspect of the present invention guides an X-ray by confining the X-ray in the core (and the planarizing layer) by total reflection at the cladding. In the region of X-rays, the real part of refractive index decreases with an increase in electron density of a material. Accordingly, the material for the cladding may be a metal having a high density. Specifically, an elementary substance of Os, Ir, Pt, Au, W, Ta, Hg, Ru, Rh, Pd, Pb, or Mo or a material containing such an element can be used. In the X-ray waveguide according to an aspect of the present invention, the material forming the core and the material forming the cladding may be designed so as to satisfy the above-mentioned Expressions (2) to (4). The cladding of such a material can be formed by, for example, sputtering or vapor deposition. The thickness of this cladding varies depending on the material and is required to be sufficiently thick to confine an X-ray in the core and also to be thin from the viewpoints of cost and manufacturing. The thickness of the cladding can be 1 nm or more and 300 nm or less, particularly, 1 nm or more and 50 nm or less. The cladding may be formed so as to have a film thickness distribution in the X-ray waveguide. For example, in order to enhance incidence through the cladding surface, the transfer efficiency is improved by forming a film with a small thickness in the incidence region, and also forming the film with a large thickness in other regions to enhance the effect of confining an X-ray.

According to the process of producing the X-ray waveguide according to an aspect of the present invention, planarization of the core/cladding interface with the planarizing layer increases the total reflection efficiency at the cladding interface and increases the efficiency of confining an X-ray in the core (or the planarizing layer). As a result, the X-ray can be guided with a high propagation efficiency. Thus, a waveguide that can effectively utilize characteristics of a periodicity-resonant waveguide mode: a reduction in loss of propagation through concentration of an electric field in the center of the core and possession of spatial coherence.

### EXAMPLES

The present invention will be described in further detail with Examples below, but is not limited thereto.

### Example 1

### (1-1) Production of Waveguide

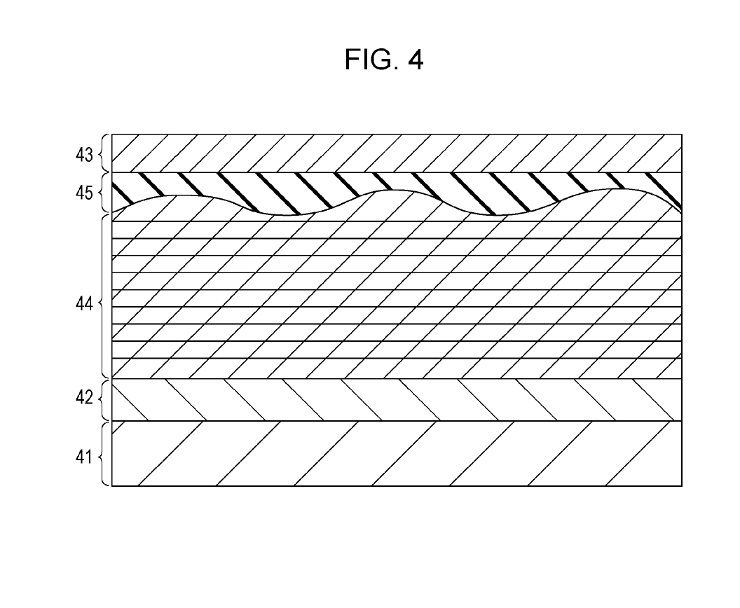

In Example 1, an X-ray waveguide having a structure shown in FIG. 4 is produced. The X-ray waveguide of Example 1 is formed such that a core 44 and a planarizing layer 45 of silicon oxide are disposed between claddings 42 and 43 of tungsten (W) on a Si substrate 41. The core 44 is a silicon oxide mesostructured film. This mesostructured film has two-dimensionally arranged pores filled with an organic substance and has a periodic structure formed in the film thickness direction. That is, the core's periodic structure is formed in a direction perpendicular to the waveguiding direction.

### (1-1-1) Formation of Cladding (42)

The cladding 42 of tungsten (W) is formed so as to have a thickness of about 15 nm on a Si substrate by sputtering.

### (1-1-2) Process of Producing Silicon Oxide Mesostructured Film

### (1-1-2-1) Preparation of Solution of Precursor for Mesostructured Film

A silicon oxide mesostructured film having a 2D hexagonal structure is produced by dip coating. A solution of a precursor of a mesostructured material is prepared by mixing ethanol, 0.01 M hydrochloric acid, and tetraethoxysilane for 20 min, adding an ethanol solution of a block polymer to the resulting solution, and stirring the resulting mixture for 3 hr. The block polymer used is ethylene oxide (20) propylene oxide (70) ethylene oxide (20) (hereinafter, referred to as EO(20)PO(70)EO(20) (the numbers in the parentheses mean the numbers of repetition of each block)). The mixture ratios (molar ratios) are tetraethoxysilane: 1.0, hydrochloric acid: 0.0011, ethanol: 5.2, block polymer: 0.0096, and ethanol: 3.5. The solution is appropriately diluted for controlling the film thickness.

### (1-1-2-2) Formation of Mesostructured Film Used as the Core

A film is formed by dip coating on a washed substrate at a lifting speed of 0.5 mms⁻¹ with dip coating equipment. After film formation, the mesostructured film is held in a constant temperature/humidity chamber at 25° C. and a relative humidity of 40% for 2 weeks and then at 80° C. for 24 hr.

### (1-1-2-3) Evaluation

The resulting mesostructured film is subjected to X-ray diffraction analysis using Bragg-Brentano arrangement. As a result, it is confirmed that this mesostructured film has high order in the normal direction of the substrate surface at a surface separation, i.e., a period in the confining direction, of 10 nm. The film thickness is about 500 nm.

### (1-1-3) Formation of Planarizing Layer

A planarizing layer of silicon oxide is formed by spin coating. A solution is prepared by mixing ethanol, 0.01 M hydrochloric acid, and tetraethoxysilane for 20 min, adding an ethanol solution of a block polymer to the resulting solution, and stirring the resulting mixture for 3 hr. The mixture ratios (molar ratios) are tetraethoxysilane: 1.0, hydrochloric acid: 0.0011, and ethanol: 8.7. The solution is appropriately diluted for controlling the film thickness. This solution is applied onto the mesostructured film prepared in step (1-1-2) with spin coating equipment to form a film. The film thickness is confirmed to be 15 nm by a reference experiment. The film is held in a constant temperature/humidity chamber at 25° C. and a relative humidity of 40% for 24 hr. Silicon oxide used for this planarizing layer is the same material as that having the highest electron density among the materials constituting the silicon oxide mesostructured film used as the core.

### (1-1-4) Formation of Cladding (43)

A tungsten cladding 43 is formed on the planarizing layer by sputtering so as to have a thickness of about 15 nm. A uniform cladding is formed by forming the planarizing layer by the same material as that having the highest electron density among the materials constituting the silicon oxide mesostructured film.

### (1-2) Relationship Between Surface Roughness and X-Ray Reflectance

The surface roughness is evaluated with a surface roughness tester. The mesostructured film prepared in step (1-1-2) has a surface roughness of about 6 nm as the root-mean-square value. The planarizing layer prepared in step (1-1-3) has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of Example 1 gives an X-ray reflectance about three times higher than that of an X-ray waveguide having the same configuration except that the planarizing layer is not provided. In addition, the X-ray waveguide of Example 1 gives an X-ray reflectance about twice higher than that of an X-ray waveguide having the same configuration except that the planarizing layer is made of polystyrene (electron density: 3.3×10²³ cm⁻³). This suggests that the effect of confining an X-ray by the cladding of an X-ray waveguide is enhanced by introducing a planarizing layer having the same electron density as that (5.7×10²³ cm⁻³) of silicon oxide, which is the material having the highest electron density among the materials constituting the silicon oxide mesostructured film used as the core.

### (1-3) Wave Guiding Characteristics

An X-ray of 10 keV is allowed to enter the waveguide, strength of the X-ray guided by a periodicity-resonant waveguide mode is measured. As a result, the X-ray waveguide of the present invention gives an intensity of waveguided X-rays about ten times higher than that of an X-ray waveguide having the same configuration except that the planarizing layer is not provided. This high intensity of waveguided X-rays is believed to be achieved by that in the X-ray waveguide of the present invention, the efficiency of confining an X-ray is increased by using a planarizing layer made of the same material as that having the highest electron density among the materials constituting the core.

### Example 2

### (2-1) Production of Waveguide

Example 2 describes an X-ray waveguide having a configuration shown in FIG. 4. The X-ray waveguide of Example 2 is formed such that a core 44 and a planarizing layer 45 of a titanium oxide/polymer composite are disposed between claddings 42 and 43 of Au on a Si substrate 41. The cladding 42 and 43 (cladding layers) are formed by sputtering so as to have a thickness of about 20 nm. The core 44 is a silicon oxide mesostructured film. This mesostructured film has two-dimensionally arranged pores filled with an organic substance and has a periodic structure formed in the film thickness direction.

### (2-1-1) Formation of Cladding (42)

The cladding 42 of Au is formed by sputtering so as to have a thickness of about 20 nm on a Ti layer having a thickness of 2 nm formed on a Si substrate.

### (2-1-2) Process of Producing Silicon Oxide Mesostructured Film

A silicon oxide mesostructured film is prepared by the same procedure as in step (1-1-2).

### (2-1-3) Formation of Planarizing Layer

A planarizing layer of a titanium oxide/polymer composite is formed by spin coating. A composite solution is prepared by adding acetic acid, 1-propanol, ethanol, and water to titanium tetraisopropoxide and stirring the resulting mixture with an ethanol/acetonitrile solvent mixture containing polyvinylpyrrolidone-b-poly(methyl methacrylate). This composite solution is applied onto the mesostructured film prepared in the previous step with spin coating equipment. The film is confirmed to have a thickness of 15 nm and an electron density of 6.6×10²³ cm⁻³ by a reference experiment. The film composed of the planarizing layer and the silicon oxide mesostructured film is held in a constant temperature/humidity chamber at 25° C. and a relative humidity of 40% for 24 hr. The titanium oxide/polymer composite used for this planarizing layer has an electron density higher than that (5.7×10²³ cm⁻³) of silicon oxide, which is the material having the highest electron density among the materials constituting the silicon oxide mesostructured film used as the core.

### (2-1-4) Formation of Cladding (43)

A gold cladding 43 is formed on the planarizing layer by sputtering so as to have a thickness of about 20 nm. A uniform cladding is formed by forming the planarizing layer by a material having a higher electron density than that of the material having the highest electron density among the materials constituting the silicon oxide mesostructured film.

### (2-2) Relationship Between Surface Roughness and X-Ray Reflectance

The surface roughness is evaluated with a surface roughness tester. The mesostructured film prepared in step (2-1-2) has a surface roughness of about 6 nm as the root-mean-square value. The planarizing layer prepared in step (2-1-3) has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of Example 2 gives an X-ray reflectance about three times higher than that of an X-ray waveguide having the same configuration except that the planarizing layer is not provided. This suggests that the effect of confining an X-ray by the cladding of an X-ray waveguide is enhanced by introducing a planarizing layer of a titanium oxide/polymer composite having a higher electron density than that of silicon oxide, which is the material having the highest electron density among the materials constituting the silicon oxide mesostructured film used as the core.

### (2-3) Wave Guiding Characteristics

An X-ray of 10 keV is allowed to enter the waveguide, and strength of the X-ray guided by a periodicity-resonant waveguide mode is measured. As a result, the X-ray waveguide of the present invention gives an intensity of waveguided X-rays about five times higher than that of an X-ray waveguide having the same configuration except that the planarizing layer is not provided. This high intensity of waveguided X-rays is believed to be achieved by that in the X-ray waveguide of the present invention, the efficiency of confining an X-ray is increased by using a planarizing layer made of a material having a higher electron density than that of the material having the highest electron density among the materials constituting the core.

### Example 3

### (3-1) Production of Waveguide

Example 3 describes an X-ray waveguide having a configuration shown in FIG. 4. The X-ray waveguide of Example 3 is formed such that a core 44 and a planarizing layer 45 of a titanium oxide are disposed between claddings 42 and 43 of tungsten (W) on a Si substrate 41. The claddings 42 and 43 are formed by sputtering so as to have a thickness of about 15 nm. The core 44 is a titanium oxide mesostructured film. This mesostructured film has a layered periodic structure where organic compound layers and titanium oxide layers are alternately stacked in the film thickness direction.

### (3-1-1) Formation of Cladding (42)

A cladding is formed by the same procedure as in step (1-1-1).

### (3-1-2) Process of Producing Titanium Oxide Mesostructured Film

### (3-1-2-1) Preparation of Solution of Precursor for Mesostructured Film

A titanium oxide mesostructured film having a lamella structure is produced by dip coating. A solution of a precursor of a mesostructured material is prepared by mixing tetraethoxytitanium with concentrated hydrochloric acid for 5 min, adding an ethanol solution of a block polymer EO(20)PO(70)EO(20) to the resulting solution, and stirring the resulting mixture for 3 hr. Instead of ethanol, methanol, propanol, 1,4-dioxane, tetrahydrofuran, or acetonitrile can also be used. The mixture ratios (molar ratios) are tetraethoxytitanium: 1.0, hydrochloric acid: 1.8, block polymer: 0.029, and ethanol: 14. The solution is appropriately diluted for controlling the film thickness.

### (3-1-2-2) Formation of Mesostructured Film

A film is formed by dip coating on a washed substrate at a lifting speed of 0.5 to 2 mms⁻¹ with dip coating equipment. After film formation, the film is held in a constant temperature/humidity chamber at 25° C. and a relative humidity of 50% for 2 weeks.

### (3-1-2-3) Evaluation

The prepared mesostructured film is subjected to X-ray diffraction analysis of Bragg-Brentano arrangement. As a result, it is confirmed that this mesostructured film has high order in the normal direction of the substrate surface at a surface separation of about 11 nm.

### (3-1-3) Formation of Planarizing Layer

A planarizing layer of a titanium oxide is formed by spin coating. A solution of a precursor is prepared by adding acetic acid, 1-propanol, ethanol, and water to titanium tetraisopropoxide and subjecting the mixture to ultrasonication for 15 min. The volume ratios of the used reagents are titanium tetraisopropoxide: 2.5, acetic acid: 5, 1-propanol: 5, ethanol: 15, and water: 1. The solution is appropriately diluted for controlling the film thickness. The solution is applied onto the mesostructured film prepared in the previous step with spin coating equipment to form a film. The planarizing layer is estimated to have a thickness of 15 nm by a reference experiment. The film composed of the planarizing layer and the titanium oxide mesostructured film is held in a constant temperature/humidity chamber at 25° C. and a relative humidity of 40% for 24 hr. The titanium oxide used for this planarizing layer is the same material as that having the highest electron density among the materials constituting the titanium oxide mesostructured film used as the core. This planarizing layer shows high resistance to the subsequent step of forming a cladding.

### (3-1-4) Formation of Cladding (43)

A tungsten cladding 43 is formed on the planarizing layer by sputtering so as to have a thickness of about 15 nm. A uniform cladding is formed by forming the planarizing layer by the same material as that having the highest electron density among the materials constituting the titanium oxide mesostructured film.

### (3-2) Relationship Between Surface Roughness and X-Ray Reflectance

The surface roughness is evaluated with a surface roughness tester. The mesostructured film prepared in step (3-1-2) has a surface roughness of about 6 nm as the root-mean-square value. The planarizing layer prepared in step (3-1-3) has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.28°: within the total reflection region of cladding) failing Bragg reflection, but being close to the Bragg angle (θ=0.32°) corresponding to the periodic structure of the core.

The X-ray waveguide of Example 3 gives an X-ray reflectance about three times higher than that of an X-ray waveguide having the same configuration except that the planarizing layer is not provided. In addition, the X-ray waveguide of Example 3 gives an X-ray reflectance about twice higher than that of an X-ray waveguide having the same configuration except that the planarizing layer is made of poly(methyl methacrylate) (electron density: 3.9×10²³ cm⁻³). This suggests that the effect of confining an X-ray by the cladding of an X-ray waveguide is enhanced by introducing a planarizing layer having the same electron density as that of titanium oxide, which is the material having the highest electron density among the materials constituting the titanium oxide mesostructured film used as the core.

### (3-3) Wave Guiding Characteristics

An X-ray of 10 keV is allowed to enter the waveguide, and strength of the X-ray guided by a periodicity-resonant waveguide mode is measured. As a result, the X-ray waveguide of the present invention gives an intensity of waveguided X-rays about five times higher than that of an X-ray waveguide having the same configuration except that the planarizing layer is not provided. This high intensity of waveguided X-rays is believed to be achieved by that in the X-ray waveguide of the present invention, the efficiency of confining an X-ray is increased by using a planarizing layer made of the same material as that having the highest electron density among the materials constituting the core.

### Example 4

### (4-1) Production of Waveguide

Example 4 describes an X-ray waveguide having a configuration shown in FIG. 4. The X-ray waveguide of Example 4 is formed such that a core 44 and a planarizing layer 45 of a niobium oxide/polymer composite are disposed between claddings 42 and 43 of Au on a Si substrate 41. The claddings 42 and 43 are formed by sputtering so as to have a thickness of about 20 nm. The core 44 is a silicon oxide mesostructured film. This mesostructured film has two-dimensionally arranged pores filled with an organic substance and has a periodic structure formed in the film thickness direction.

### (4-1-1) Formation of Cladding (42)

A cladding is formed by the same procedure as in step (2-1-1).

### (4-1-2) Process of Producing Silicon Oxide Mesostructured Film

A silicon oxide mesostructured film is prepared by the same procedure as in step (1-1-2).

### (4-1-3) Formation of Planarizing Layer

A planarizing layer of a niobium oxide/polymer composite is formed by spin coating. A composite solution is prepared by stirring a mixture of niobium oxide, acetic acid, 1-propanol, and water with an ethanol/acetonitrile solvent mixture containing polyvinylpyrrolidone-b-poly(methyl methacrylate). This composite solution is applied onto the mesostructured film prepared in the previous step with spin coating equipment. The film is confirmed to have a thickness of 15 nm and an electron density of 8.6×10²³ cm⁻³ by a reference experiment. The film is held in a constant temperature/humidity chamber at 25° C. and a relative humidity of 40% for 24 hr. The niobium oxide/polymer composite used for this planarizing layer has an electron density higher than that (5.7×10²³ cm⁻³) of silicon oxide, which is the material having the highest electron density among the materials constituting the silicon oxide mesostructured film used as the core.

### (4-1-4) Formation of Cladding (43)

A cladding is prepared by the same procedure as in step (2-1-4).

### (4-2) Relationship Between Surface Roughness and X-Ray Reflectance

The surface roughness is evaluated with a surface roughness tester. The mesostructured film prepared in step (4-1-2) has a surface roughness of about 6 nm as the root-mean-square value. The planarizing layer prepared in step (4-1-3) has a surface roughness of about 3 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of Example 4 gives an X-ray reflectance about twice higher than that of an X-ray waveguide having the same configuration except that the planarizing layer is not provided. This suggests that the effect of confining an X-ray by the cladding of an X-ray waveguide is enhanced by introducing a planarizing layer of a niobium oxide/polymer composite having a higher electron density than that of silicon oxide, which is the material having the highest electron density among the materials constituting the silicon oxide mesostructured film used as the core.

### (4-3) Wave Guiding Characteristics

An X-ray of 10 keV is allowed to enter the waveguide, and strength of the X-ray guided by a periodicity-resonant waveguide mode is measured. As a result, the X-ray waveguide of the present invention gives an intensity of waveguided X-rays about twice higher than that of an X-ray waveguide having the same configuration except that the planarizing layer is not provided. This high intensity of waveguided X-rays is believed to be achieved by that in the X-ray waveguide of the present invention, the efficiency of confining an X-ray is increased by using a planarizing layer made of a material having an electron density higher than that of the material having the highest electron density among the materials constituting the core.

### Example 5

### (5-1) Production of Waveguide

Example 5 describes an X-ray waveguide having a configuration shown in FIG. 4. The X-ray waveguide of Example 5 is formed such that a core 44 and a planarizing layer 45 of a zinc oxide/polymer composite are disposed between claddings 42 and 43 of Au on a Si substrate 41. The claddings 42 and 43 are formed by sputtering so as to have a thickness of about 20 nm. The core 44 is a silicon oxide mesostructured film. This mesostructured film has two-dimensionally arranged pores filled with an organic substance and has a periodic structure formed in the film thickness direction.

### (5-1-1) Formation of Cladding (42)

A cladding is formed by the same procedure as in step (2-1-1).

### (5-1-2) Process of Producing Silicon Oxide Mesostructured Film

A silicon oxide mesostructured film is prepared by the same procedure as in step (1-1-2).

### (5-1-3) Formation of Planarizing Layer

A planarizing layer of a zinc oxide/polymer composite is formed by spin coating. A composite solution is prepared by adding ethanol amine and hydrochloric acid to zinc acetate and ethanol and stirring the resulting mixture with an ethanol/acetonitrile solvent mixture containing polyvinylpyrrolidone-b-poly(methyl methacrylate). This composite solution is applied onto the mesostructured film prepared in the previous step with spin coating equipment. The film is confirmed to have a thickness of 15 nm and an electron density of 8.8×10²³ cm⁻³ by a reference experiment. The film is held in a constant temperature/humidity chamber at 25° C. and a relative humidity of 40% for 24 hr. The zinc oxide/polymer composite used for this planarizing layer has an electron density higher than that (5.7×10²³ cm⁻³) of silicon oxide, which is the material having the highest electron density among the materials constituting the silicon oxide mesostructured film used as the core.

### (5-1-4) Formation of Cladding (43)

A cladding is formed by the same procedure as in step (2-1-4).

### (5-2) Relationship Between Surface Roughness and X-Ray Reflectance

The surface roughness is evaluated with a surface roughness tester. The mesostructured film prepared in step (5-1-2) has a surface roughness of about 6 nm as the root-mean-square value. The planarizing layer prepared in step (5-1-3) has a surface roughness of about 3 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of Example 5 gives an X-ray reflectance about twice higher than that of an X-ray waveguide having the same configuration except that the planarizing layer is not provided. This suggests that the effect of confining an X-ray by the cladding of an X-ray waveguide is enhanced by introducing a planarizing layer of a zinc oxide/polymer composite having a higher electron density than that of silicon oxide, which is the material having the highest electron density among the materials constituting the silicon oxide mesostructured film used as the core.

### (5-3) Wave Guiding Characteristics

An X-ray of 10 keV is allowed to enter the waveguide, and strength of the X-ray guided by a periodicity-resonant waveguide mode is measured. As a result, the X-ray waveguide of the present invention gives an intensity of waveguided X-rays about twice higher than that of an X-ray waveguide having the same configuration except that the planarizing layer is not provided. This high intensity of waveguided X-rays is believed to be achieved by that in the X-ray waveguide of the present invention, the efficiency of confining an X-ray is increased by using a planarizing layer made of a material having an electron density higher than that of the material having the highest electron density among the materials constituting the core.

### Example 6

### (6-1) Production of Waveguide

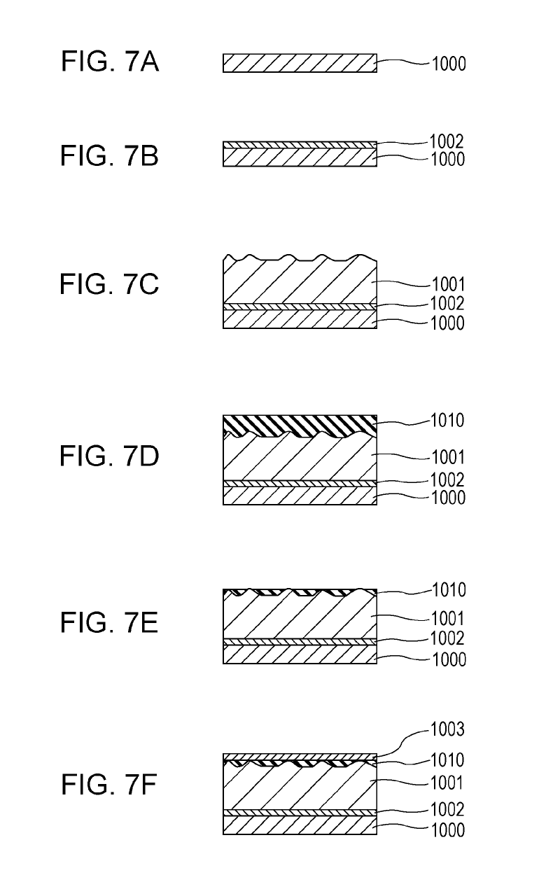

In this Example, an X-ray waveguide having a configuration shown in FIG. 6 is produced. The X-ray waveguide of this Example includes a cladding 1002 of tungsten (W), a core 1001, a planarizing layer 1010, and a cladding 1003 on a Si substrate 1000. The core 1001 is a silicon oxide mesostructured film. This mesostructured film has two-dimensionally arranged pores filled with an organic substance and has a periodic structure formed in the film thickness direction. The planarizing layer is made of silicon oxide. The process of producing the X-ray waveguide of this Example will be described with reference to FIGS. 7A to 7F.

### (6-1-1) Formation of Cladding (FIG. 7B)

A cladding 1002 of tungsten (W) is formed on a Si substrate by sputtering so as to have a thickness of about 15 nm.

### (6-1-2) Formation of Core (Formation of Silicon Oxide Mesostructured Film) (FIG. 7C)

### (6-1-2-1) Preparation of Solution of Precursor for Mesostructured Film

A silicon oxide mesostructured film 1001 having a two-dimensional hexagonal structure is formed by dip coating. A solution of a precursor of a mesostructured material is prepared by mixing ethanol, 0.01 M hydrochloric acid, and tetraethoxysilane for 20 min, adding an ethanol solution of a block polymer to the resulting solution, and stirring the mixture for 3 hr. The block polymer can be ethylene oxide (20) propylene oxide (70) ethylene oxide (20) (hereinafter, referred to as EO(20)PO(70)EO(20) (the numbers in the parentheses mean the numbers of repetition of each block)). The mixture ratios (molar ratios) are tetraethoxysilane: 1.0, hydrochloric acid: 0.0011, ethanol: 5.2, block polymer: 0.0096, and ethanol: 3.5. The solution is appropriately diluted for controlling the film thickness.

### (6-1-2-2) Formation of Mesostructured Film

A film is formed by dip coating on a washed substrate at a lifting speed of 0.5 mms⁻¹ with dip coating equipment. After film formation, the mesostructured film is held in a constant temperature/humidity chamber at 25° C. and a relative humidity of 40% for 2 weeks and then at 80° C. for 24 hr. The resulting mesostructured film is subjected to X-ray diffraction analysis using Bragg-Brentano arrangement. As a result, it is confirmed that this mesostructured film has high order in the normal direction of the substrate surface at a surface separation, i.e., a period in the confining direction, of 10 nm. The film thickness is about 500 nm. As described above, the mesostructured film has two-dimensionally arranged pores filled with an organic substance and has a periodic structure formed in the film thickness direction.

### (6-1-3) Formation of Planarizing Layer (FIG. 7D)

The planarizing layer 1010 of silicon oxide is formed by spin coating of an SOG material. An SOG material, NAX120 available from AZ Electronic Materials Corp., is diluted with dibutyl ether and spin-coated onto the substrate. The substrate provided with the SOG material is held in a constant temperature/humidity chamber at 25° C. and a relative humidity of 40% for 24 hr. In this step, the SOG material in a liquid form flows into the concave portions of the rough surface of the core and thereby planarizes the surface. The resulting planarizing layer has a thickness of 200 nm.

### (6-1-4) Planarization Treatment

Subsequently, the resulting planarizing layer is polished for further planarization. Polishing is performed by a polishing solution manufactured by Buehler, Ltd., which is a water dispersion of colloidal silica particles having a diameter of 5 nm, using a chemical mechanical polishing (CMP) apparatus (manufactured by MAT Inc.). The planarizing layer is removed in this step by an amount corresponding to a thickness of 200 nm by controlling the polishing time. A cross-section of the resulting substrate is analyzed with a transmission electron microscope (TEM) to confirm that the planarizing layer formed in step (6-1-3) is mostly removed to form a smooth surface in such a manner that the core material is partially exposed to the surface and other regions are filled with the material for the planarizing layer. The ratio of the surface area of the cladding to the total surface area of the cladding and the planarizing layer is 90% (FIG. 7E).

### (6-1-5) Formation of Cladding

A cladding 1003 of tungsten (W) is formed on the surface of the core (and a buffer material) by sputtering so as to have a thickness of about 15 nm.

### (6-2) Relationship Between Surface Roughness and X-Ray Reflectance

The surface roughness is evaluated with a surface roughness tester. The mesostructured film prepared in step (6-1-2) has a surface roughness of about 12 nm as the root-mean-square value. The mesostructured material surface planarized in step (6-1-4) has a surface roughness of about 0.8 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about four times higher than that of an X-ray waveguide having the same configuration except that the planarizing layer is not prepared by omitting steps (6-1-3) and (6-1-4). This suggests that the effect of confining an X-ray by the cladding of an X-ray waveguide is enhanced through planarization treatment using a planarizing layer.

### (6-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about 12 times higher than that of an X-ray waveguide having the same configuration except that the planarizing layer is not prepared by omitting steps (6-1-3) and (6-1-4). This high intensity of waveguided X-rays is believed to be achieved by that in the X-ray waveguide of the present invention, the efficiency of confining an X-ray is increased by planarization treatment using a planarizing layer.

### Example 7

### (7-1) Production of Waveguide

In this Example, an X-ray waveguide having a configuration shown in FIG. 6 is produced. The X-ray waveguide of this Example includes a cladding 1002 of tungsten (W), a core 1001, a planarizing layer 1010, and a cladding 1003 on a Si substrate 1000. The core 1001 is a silicon oxide mesostructured film. This mesostructured film has two-dimensionally arranged pores filled with an organic substance and has a periodic structure formed in the film thickness direction (the direction perpendicular to the wave-guiding direction). The planarizing layer is made of silicon oxide. The process of producing the X-ray waveguide of this Example will be described with reference to FIGS. 7A to 7F.

### (7-1-1) Formation of Cladding (FIG. 7B)

A cladding is formed by the same procedure as in step (6-1-1).

### (7-1-2) Process of Producing Silicon Oxide Mesostructured Film

A mesostructured film is formed by the same procedure as in step (6-1-2).

### (7-1-3) Formation of Planarizing Layer (FIG. 7D)

The planarizing layer 1010 of silicon oxide is formed by CVD so as to have a thickness of 200 nm.

### (7-1-4) Planarization Treatment

Subsequently, the resulting planarizing layer is polished for further planarization. Polishing is performed by a polishing solution manufactured by Buehler, Ltd., which is a water dispersion of colloidal silica particles having a diameter of 60 nm, using a polishing apparatus (manufactured by MAT Inc.). The planarizing layer is removed in this step by an amount corresponding to a thickness of 200 nm by controlling the polishing time. A cross-section of the resulting substrate is analyzed with a transmission electron microscope (TEM) to confirm that the planarizing layer formed in step (7-1-3) is mostly removed to form a smooth surface in such a manner that the core material is partially exposed to the surface and other regions are filled with the material for the planarizing layer. The ratio of the surface area of the cladding to the total surface area of the cladding and the planarizing layer is 65% (FIG. 7E).

### (7-1-5) Formation of Cladding

A cladding 1003 of tungsten is formed on the planarizing layer by sputtering so as to have a thickness of about 15 nm. The cladding is formed so as to adhere to the surface composed of the core and the planarizing layer.

### (7-2) Relationship Between Surface Roughness and X-Ray Reflectance

The surface roughness is evaluated with a surface roughness tester. The mesostructured film prepared in step (7-1-2) has a surface roughness of about 12 nm as the root-mean-square value. The planarizing layer planarized in step (7-1-4) has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about three times higher than that of an X-ray waveguide having the same configuration except that the planarizing layer is not prepared by omitting steps (7-1-3) and (7-1-4). This suggests that the effect of confining an X-ray by the cladding of an X-ray waveguide is enhanced through planarization treatment using a planarizing layer.

### (7-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about six times higher than that of an X-ray waveguide having the same configuration except that the planarizing layer is not prepared by omitting steps (7-1-3) and (7-1-4). This high intensity of waveguided X-rays is believed to be achieved by that in the X-ray waveguide of the present invention, the efficiency of confining an X-ray is increased by planarization treatment using a planarizing layer.

### Example 8

### (8-1) Production of Waveguide

In this Example, an X-ray waveguide having a configuration shown in FIG. 6 is produced. The X-ray waveguide of this Example includes a cladding 1002 of tungsten (W), a core 1001, a planarizing layer 1010, and a cladding 1003 on a Si substrate 1000. The core 1001 is a titanium oxide mesostructured film. This mesostructured film has a layered periodic structure where organic compound layers and titanium oxide layers are alternately stacked in the film thickness direction. The planarizing layer is made of titanium oxide. The process of producing the X-ray waveguide of this Example will be described with reference to FIGS. 7A to 7F.

### (8-1-1) Formation of Cladding (FIG. 7B)

A cladding is formed by the same procedure as in step (6-1-1).

### (8-1-2) Process of Producing Titanium Oxide Mesostructured Film

### (8-1-2-1) Preparation of Solution of Precursor for Mesostructured Film

A titanium oxide mesostructured film having a lamella structure is produced by dip coating. A solution of a precursor of a mesostructured material is prepared by mixing tetraethoxytitanium with concentrated hydrochloric acid for 5 min, adding an ethanol solution of a block polymer EO(20)PO(70)EO(20) to the resulting solution, and stirring the resulting mixture for 3 hr. Instead of ethanol, methanol, propanol, 1,4-dioxane, tetrahydrofuran, or acetonitrile can also be used. The mixture ratios (molar ratios) are tetraethoxytitanium: 1.0, hydrochloric acid: 1.8, block polymer: 0.029, and ethanol: 14. The solution is appropriately diluted for controlling the film thickness.

### (8-1-2-2) Formation of Mesostructured Film

A film is formed by dip coating on a washed substrate at a lifting speed of 0.5 to 2 mms⁻¹ with dip coating equipment. After film formation, the film is held in a constant temperature/humidity chamber at 25° C. and a relative humidity of 50% for 2 weeks. The resulting mesostructured film is subjected to X-ray diffraction analysis using Bragg-Brentano arrangement. As a result, it is confirmed that this mesostructured film has high order in the normal direction of the substrate surface at a surface separation of about 11 nm. As described above, this mesostructured film has a layered periodic structure where organic compound layers and titanium oxide layers are alternately stacked in the film thickness direction.

### (8-1-3) Formation of Planarizing Layer (FIG. 7D)

The planarizing layer 1010 of titanium oxide is formed by CVD so as to have a thickness of 250 nm.

### (8-1-4) Planarization Treatment

Subsequently, the resulting planarizing layer is subjected to reactive ion etching (RIE). RIE is performed using a dry etching apparatus to remove the planarizing layer by an amount corresponding to a thickness of 250 nm. A cross-section of the resulting substrate is analyzed with a transmission electron microscope (TEM) to confirm that the planarizing layer formed in step (8-1-3) is mostly removed to form a smooth surface in such a manner that the core material is partially exposed to the surface and other regions are filled with the material for the planarizing layer. The ratio of the surface area of the cladding to the total surface area of the cladding and the planarizing layer is 70% (FIG. 7E).

### (8-1-5) Formation of Cladding

A cladding 1003 of tungsten is formed on the planarizing layer by sputtering so as to have a thickness of about 15 nm. The cladding is formed so as to adhere to the surface composed of the core and the planarizing layer.

### (8-2) Relationship Between Surface Roughness and X-Ray Reflectance

The surface roughness is evaluated with a surface roughness tester. The mesostructured film prepared in step (8-1-2) has a surface roughness of about 6 nm as the root-mean-square value. The planarizing layer planarized in step (8-1-4) has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about three times higher than that of an X-ray waveguide having the same configuration except that the planarizing layer is not prepared by omitting steps (8-1-3) and (8-1-4). This suggests that the effect of confining an X-ray by the cladding of an X-ray waveguide is enhanced through planarization treatment using a planarizing layer.

### (8-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about six times higher than that of an X-ray waveguide having the same configuration except that the planarizing layer is not prepared by omitting steps (8-1-3) and (8-1-4). This high intensity of waveguided X-rays is believed to be achieved by that in the X-ray waveguide of the present invention, the efficiency of confining an X-ray is increased by planarization treatment using a planarizing layer.

### Example 9

### (9-1) Production of Waveguide

In this Example, an X-ray waveguide having a configuration shown in FIG. 6 is produced. The X-ray waveguide of this Example includes a cladding 1002 of tungsten (W), a core 1001, a planarizing layer 1010, and a cladding 1003 on a Si substrate 1000. The core 1001 is a silicon oxide mesostructured film. This mesostructured film has two-dimensionally arranged pores filled with an organic substance and has a periodic structure formed in the film thickness direction. In this Example, the planarizing layer is also a silicon oxide mesostructured film. The mesostructured film used as the planarizing layer has a structure having a lower degree of periodicity than that of the core. The process of producing the X-ray waveguide of this Example will be described with reference to FIGS. 7A to 7F.

### (9-1-1) Formation of Cladding (FIG. 7B)

A cladding is formed by the same procedure as in step (6-1-1).

### (9-1-2) Process of Producing Silicon Oxide Mesostructured Film

A mesostructured film is formed by the same procedure as in step (6-1-2).

### (9-1-3) Formation of Planarizing Layer (FIG. 7D)

### (9-1-3-1) Preparation of Solution of Precursor for Mesostructured Film

A silicon oxide mesostructured film as the planarizing layer 1010 is prepared by dip coating. A solution of a precursor of a mesostructured material is prepared by mixing and stirring 2.6 g of tetraalkoxysilane, 0.7 g of block polymer (Pluronic P123, manufactured by BASF), 13 g of 1-propanol, and 1.35 g of an aqueous solution of 0.01 M hydrochloric acid.

### (9-1-3-2) Formation of Mesostructured Film

A film is formed by dip coating on a washed substrate at a lifting speed of 0.5 mms⁻¹ with dip coating equipment. After film formation, the mesostructured film is held in a constant temperature/humidity chamber at 25° C. and a relative humidity of 40% for 2 weeks and then at 80° C. for 24 hr. The resulting mesostructured film formed as the planarizing layer has a structure having a lower degree of periodicity than that of the mesostructured film formed as the core (flatness is increased by imparting a distribution in periodicity of the structure). The planarizing layer is formed so as to have a thickness of 200 nm.

### (9-1-4) Planarization Treatment

Subsequently, the resulting planarizing layer is polished for further planarization. Polishing is performed by a polishing solution manufactured by Buehler, Ltd., which is a water dispersion of colloidal silica particles having a diameter of 60 nm, using a polishing apparatus (manufactured by MAT Inc.). The planarizing layer is removed in this step by an amount corresponding to a thickness of 200 nm by controlling the polishing time. A cross-section of the resulting substrate is analyzed with a transmission electron microscope (TEM) to confirm that the planarizing layer formed in step (9-1-3) is mostly removed to form a smooth surface in such a manner that the core material is partially exposed to the surface and other regions are filled with the material for the planarizing layer. The ratio of the surface area of the cladding to the total surface area of the cladding and the planarizing layer is 80% (FIG. 7E).

### (9-1-5) Formation of Cladding

A cladding 1003 of tungsten is formed on the planarizing layer by sputtering so as to have a thickness of about 15 nm. The cladding is formed so as to adhere to the surface composed of the core and the planarizing layer.

### (9-2) Relationship Between Surface Roughness and X-Ray Reflectance

The surface roughness is evaluated with a surface roughness tester. The mesostructured film prepared in step (9-1-2) has a surface roughness of about 12 nm as the root-mean-square value. The planarizing layer planarized in step (9-1-4) has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about three times higher than that of an X-ray waveguide having the same configuration except that the planarizing layer is not prepared by omitting steps (9-1-3) and (9-1-4). This suggests that the effect of confining an X-ray by the cladding of an X-ray waveguide is enhanced through planarization treatment using a planarizing layer.

### (9-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about eight times higher than that of an X-ray waveguide having the same configuration except that the planarizing layer is not prepared by omitting steps (9-1-3) and (9-1-4). This high intensity of waveguided X-rays is believed to be achieved by that in the X-ray waveguide of the present invention, the efficiency of confining an X-ray is increased by planarization treatment using a planarizing layer.

### Example 10

### (10-1) Production of Waveguide

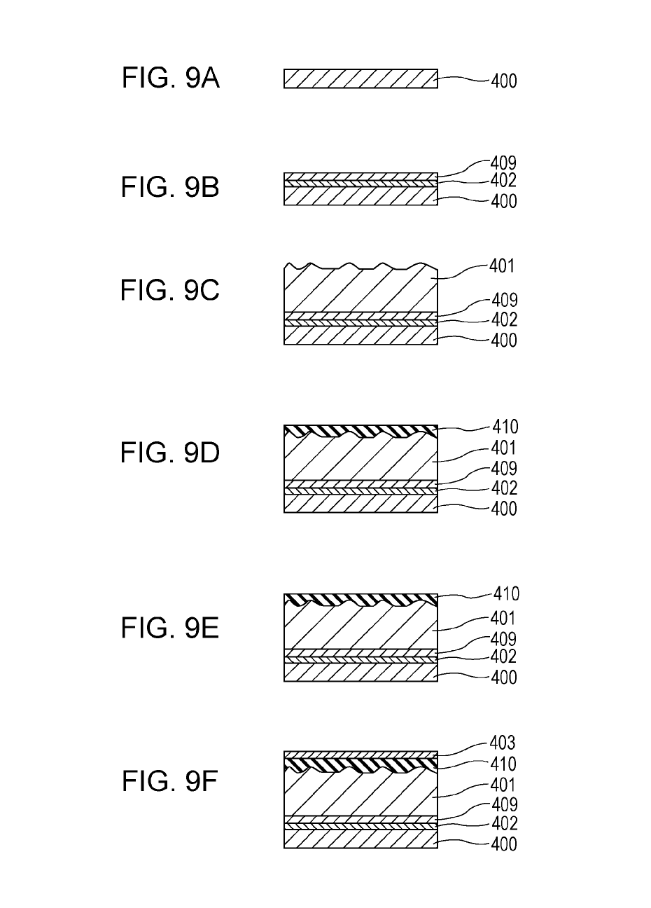

This Example describes an X-ray waveguide shown in FIG. 9F where a planarizing layer is disposed between a core and a cladding on each side of the core. In the X-ray waveguide produced in this Example, a cladding 402 of tungsten (W), a planarizing layer 409, a core 401, a planarizing layer 410, and a cladding 403 are stacked in this order on a Si substrate 400. The core 401 is a silicon oxide mesostructured film. This mesostructured film has two-dimensionally arranged pores filled with an organic substance and has a periodic structure formed in the film thickness direction. In this Example, the planarizing layer is also a silicon oxide mesostructured film. The mesostructured film used as the planarizing layer has a structure having a lower degree of periodicity than that of the core, but has a smooth surface. The process of producing the X-ray waveguide of this Example will be described with reference to FIGS. 9A to 9F.

### (10-1-1) Formation of Cladding (FIG. 9B)

A cladding 402 of tungsten (W) is formed on a Si substrate by sputtering so as to have a thickness of about 15 nm.

### (10-1-2) Formation of Planarizing Layer (FIG. 9B)

### (10-1-2-1) Preparation of Solution of Precursor for Mesostructured Film

A silicon oxide mesostructured film as the planarizing layer 409 is prepared by dip coating. A solution of a precursor of a mesostructured material is prepared by mixing and stirring 2.6 g of tetraalkoxysilane, 0.7 g of block polymer (Pluronic P123, manufactured by BASF), 13 g of 1-propanol, and 1.35 g of an aqueous solution of 0.01 M hydrochloric acid.

### (10-1-2-2) Formation of Mesostructured Film

A film is formed by dip coating on a washed substrate at a lifting speed of 0.5 mms⁻¹ with dip coating equipment. After film formation, the film is held in a constant temperature/humidity chamber at 25° C. and a relative humidity of 40% for 2 weeks and then at 80° C. for 24 hr. The resulting mesostructured film formed as the planarizing layer has a structure having a lower degree of periodicity than that of the mesostructured film formed as the core (flatness is increased by imparting a distribution in periodicity to the structure). The planarizing layer 409 is formed so as to have a thickness of 100 nm.

### (10-1-3) Formation of Core (Formation of Silicon Oxide Mesostructured Film) (FIG. 9C)

### (10-1-3-1) Preparation of Solution of Precursor for Mesostructured Film

A silicon oxide mesostructured film 401 having a 2D hexagonal structure is produced by dip coating. A solution of a precursor of a mesostructured material is prepared by mixing ethanol, 0.01 M hydrochloric acid, and tetraethoxysilane for 20 min, adding an ethanol solution of a block polymer to the resulting solution, and stirring the resulting mixture for 3 hr. The block polymer used is ethylene oxide (20) propylene oxide (70) ethylene oxide (20) (hereinafter, referred to as EO(20)PO(70)EO(20) (the numbers in the parentheses mean the numbers of repetition of each block)). Instead of ethanol, methanol, propanol, 1,4-dioxane, tetrahydrofuran, or acetonitrile can also be used. The mixture ratios (molar ratios) are tetraethoxysilane: 1.0, hydrochloric acid: 0.0011, ethanol: 5.2, block polymer: 0.0096, and ethanol: 3.5. The solution is appropriately diluted for controlling the film thickness.

### (10-1-3-2) Formation of Mesostructured Film

A film is formed by dip coating on a washed substrate at a lifting speed of 0.5 mms⁻¹ with dip coating equipment. After film formation, the film is held in a constant temperature/humidity chamber at 25° C. and a relative humidity of 40% for 2 weeks and then at 80° C. for 24 hr. The resulting mesostructured film is subjected to X-ray diffraction analysis using Bragg-Brentano arrangement. As a result, it is confirmed that this mesostructured film has high order in the normal direction of the substrate surface at a surface separation, i.e., a period in the confining direction, of 10 nm. The film thickness is about 500 nm.

### (10-1-4) Formation of Planarizing Layer (FIG. 9D)

A silicon oxide mesostructured film as the planarizing layer 410 is formed by the same procedure as in (1-1-2) so as to have a thickness of 100 nm.

### (10-1-5) Formation of Cladding (FIG. 9F)

A cladding 403 of tungsten (W) is formed on the surface of the core (and a buffer material) by sputtering so as to have a thickness of about 15 nm.

### (10-2) Relationship Between Surface Roughness and X-Ray Reflectance

The surface roughness is evaluated with a surface roughness tester. The mesostructured film 401 that serves as the core of an X-ray waveguide of Example 10 when the planarizing layer is not formed by omitting steps (10-1-2) and (10-1-4) has a surface roughness of about 12 nm as the root-mean-square value. The planarizing layer 410 formed on the core 401 in the production process of this Example using a planarizing layer has a surface roughness of about 1 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about three times higher than that of an X-ray waveguide produced by a process not using the planarizing layer. This suggests that the effect of confining an X-ray by the cladding of an X-ray waveguide is enhanced through planarization by a planarizing layer.

### (10-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about six times higher than that of an X-ray waveguide produced by a process not using the planarizing layer. This high intensity of waveguided X-rays is believed to be achieved by that in the X-ray waveguide of the present invention, the efficiency of confining an X-ray is increased by planarization by a planarizing layer.

### Example 11

### (11-1) Production of Waveguide

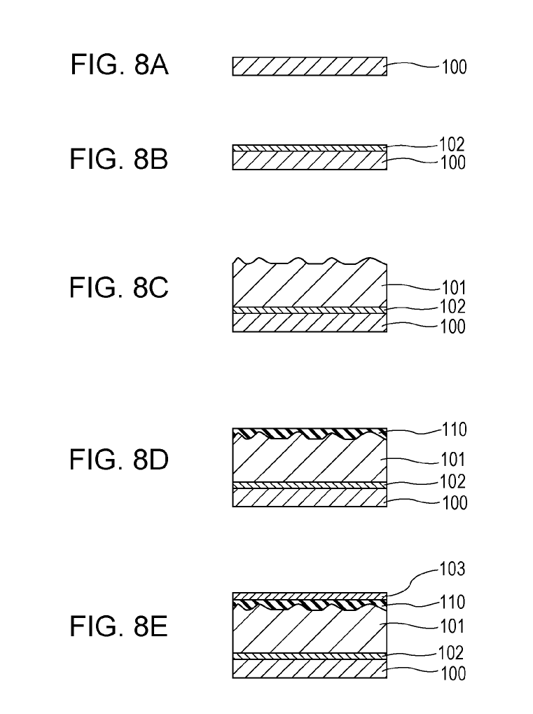

This Example describes an X-ray waveguide having a structure shown in FIG. 8E where a planarizing layer is disposed between a core and a cladding on one side of the core. In the X-ray waveguide produced in this Example, a cladding 102 of tungsten (W), a core 101, a planarizing layer 110, and a cladding 103 are stacked in this order on a Si substrate 100. The core 101 is a silicon oxide mesostructured film. This mesostructured film has two-dimensionally arranged pores filled with an organic substance and has a periodic structure formed in the film thickness direction. In this Example, the planarizing layer is also a silicon oxide mesostructured film. The mesostructured film used as the planarizing layer has a structure having a lower degree of periodicity than that of the core, but has a smooth surface. The process of producing the X-ray waveguide of this Example will be described with reference to FIGS. 8A to 8E.

### (11-1-1) Formation of Cladding (FIG. 8B)

A cladding is formed by the same procedure as in step (10-1-1).

### (11-1-2) Formation of Core (Formation of Silicon Oxide Mesostructured Film) (FIG. 8C)

A mesostructured film is formed by the same procedure as in step (10-1-3).

### (11-1-3) Formation of Planarizing Layer (FIG. 8D)

A mesostructured film is formed by the same procedure as in step (10-1-4). The resulting planarizing layer has a thickness of 100 nm.

### (11-1-4) Formation of Cladding (FIG. 8E)

A cladding 103 of tungsten is formed on the planarizing layer by sputtering so as to have a thickness of about 15 nm.

### (11-2) Relationship Between Surface Roughness and X-Ray Reflectance

The surface roughness is evaluated with a surface roughness tester. The mesostructured film 101 that serves as the core formed in step (11-1-2) has a surface roughness of about 12 nm as the root-mean-square value. The planarizing layer 110 planarized in step (11-1-3) has a surface roughness of about 1 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about three times higher than that of an X-ray waveguide produced by a process not using the planarizing layer. This suggests that the effect of confining an X-ray by the cladding of an X-ray waveguide is enhanced through planarization by a planarizing layer.

### (11-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about ten times higher than that of an X-ray waveguide produced by a process not using the planarizing layer. This high intensity of waveguided X-rays is believed to be achieved by that in the X-ray waveguide, the efficiency of confining an X-ray is increased by planarization by a planarizing layer.

### Example 12

### (12-1) Production of Waveguide

This Example describes an X-ray waveguide having a configuration shown in FIG. 10F formed by through formation of a planarizing layer on one side of a core and further planarization treatment by etching. In the X-ray waveguide produced in this Example, a cladding 502 of tungsten (W), a core 501, a planarizing layer 510, and a cladding 503 are stacked in this order on a Si substrate 500. The core 501 is a silicon oxide mesostructured film. This mesostructured film has two-dimensionally arranged pores filled with an organic substance and has a periodic structure formed in the film thickness direction. In this Example, the planarizing layer is a silicon oxide film. The process of producing the X-ray waveguide of this Example will be described with reference to FIGS. 10A to 10F.

### (12-1-1) Formation of Cladding (FIG. 10B)

A cladding is formed by the same procedure as in step (10-1-1).

### (12-1-2) Formation of Core (Silicon Oxide Mesostructured Film) (FIG. 10C)

A mesostructured film is formed by the same procedure as in step (10-1-3).

### (12-1-3) Formation of Planarizing Layer (FIG. 10D)

The planarizing layer 510 of silicon oxide is formed by spin coating of an SOG material. An SOG material, NAX120 available from AZ Electronic Materials Corp., is spin-coated onto the substrate. The substrate provided with the SOG material is held in a constant temperature/humidity chamber at 25° C. and a relative humidity of 40% for 24 hr. The resulting planarizing layer has a thickness of 400 nm.

### (12-1-4) Planarization Treatment

Subsequently, the resulting planarizing layer is subjected to reactive ion etching (RIE). RIE is performed using a dry etching apparatus to remove the planarizing layer by an amount corresponding to a thickness of 280 nm and thereby to form a planarizing layer 510 finally having a thickness of 120 nm on the mesostructured film as the core 501.

### (12-1-5) Formation of Cladding

A cladding 503 of tungsten is formed on the planarizing layer by sputtering so as to have a thickness of about 15 nm. The cladding is formed so as to adhere to the surface of the planarizing layer 510.

### (12-2) Relationship Between Surface Roughness and X-Ray Reflectance

The surface roughness is evaluated with a surface roughness tester. The mesostructured film 501 that serves as the core formed in step (12-1-2) has a surface roughness of about 12 nm as the root-mean-square value. The surface planarized in steps (12-1-3) and (12-1-4) using the planarizing layer has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about two and half times higher than that of an X-ray waveguide produced by a process not using the planarizing layer. This suggests that the effect of confining an X-ray by the cladding of an X-ray waveguide is enhanced through planarization by a planarizing layer.

### (12-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about twice higher than that of an X-ray waveguide produced by a process not using the planarizing layer. This high intensity of waveguided X-rays is believed to be achieved by that in the X-ray waveguide of this Example, the efficiency of confining an X-ray is increased by planarization using a planarizing layer.

### Example 13

### (13-1) Production of Waveguide

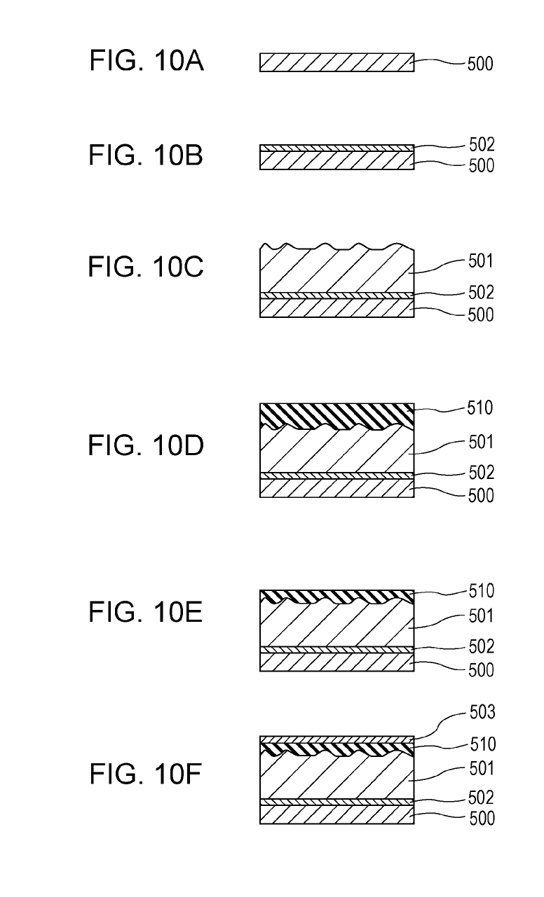

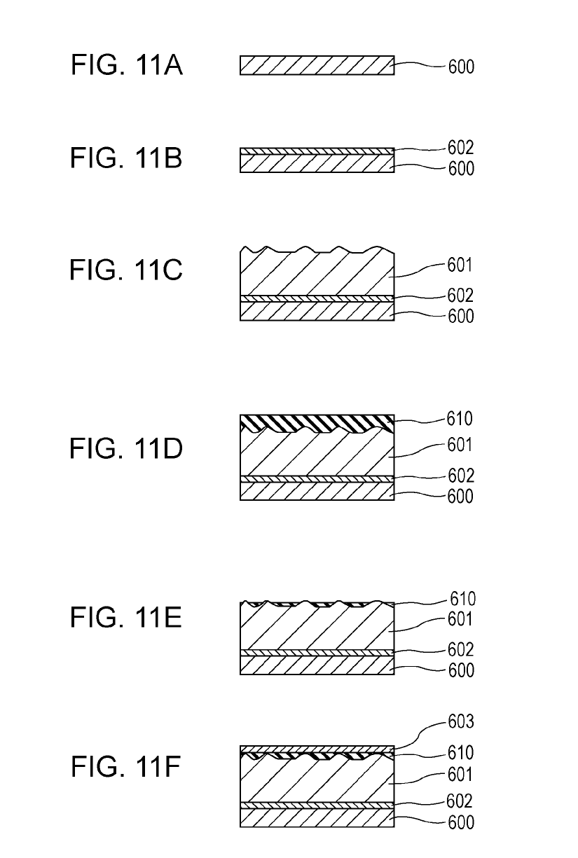

This Example describes an X-ray waveguide having a configuration shown in FIG. 11F where a cladding is formed on the surface composed of a core and a planarizing layer through formation of the planarizing layer on one side of the core and further planarization treatment by polishing.

In the X-ray waveguide produced in this Example, a cladding 602 of tungsten (W), a core 601, a planarizing layer 610, and a cladding 603 are stacked in this order on a Si substrate 600. The core 601 is a silicon oxide mesostructured film. This mesostructured film has two-dimensionally arranged pores filled with an organic substance and has a periodic structure formed in the film thickness direction. In this Example, the planarizing layer is a silicon oxide film. The process of producing the X-ray waveguide of this Example will be described with reference to FIGS. 11A to 11F.

### (13-1-1) Formation of Cladding (FIG. 11B)

A cladding is formed by the same procedure as in step (10-1-1).

### (13-1-2) Formation of Core (Silicon Oxide Mesostructured Film) (FIG. 11C)

A mesostructured film is formed by the same procedure as in step (10-1-3).

### (13-1-3) Formation of Planarizing Layer (FIG. 11D)

The planarizing layer 610 of silicon oxide is formed by spin coating of an SOG material. An SOG material, NAX120 available from AZ Electronic Materials Corp., is spin-coated onto the substrate. The substrate provided with the SOG material is held in a constant temperature/humidity chamber at 25° C. and a relative humidity of 40% for 24 hr. The resulting planarizing layer has a thickness of 200 nm.

### (13-1-4) Planarization Treatment

Subsequently, the resulting planarizing layer is polished for further planarization. Polishing is performed by a polishing solution manufactured by Buehler, Ltd., which is a water dispersion of colloidal silica particles having a diameter of 5 nm, using a CMP apparatus (manufactured by MAT Inc.). The planarizing layer is removed in this step by an amount corresponding to a thickness of 200 nm by controlling the polishing time. A cross-section of the resulting substrate is analyzed with a transmission electron microscope (TEM) to confirm that the planarizing layer formed in step (13-1-3) is mostly removed to form a smooth surface in such a manner that the core material is partially exposed to the surface and other regions are filled with the material for the planarizing layer (FIG. 11E).

### (13-1-5) Formation of Cladding

A cladding 603 of tungsten is formed on the planarizing layer by sputtering so as to have a thickness of about 15 nm. The cladding is formed so as to adhere to the surface composed of the core 601 and the planarizing layer 610.

### (13-2) Relationship Between Surface Roughness and X-Ray Reflectance

The surface roughness is evaluated with a surface roughness tester. The mesostructured film 601 that serves as the core formed in step (13-1-2) has a surface roughness of about 12 nm as the root-mean-square value. The surface planarized in steps (13-1-3) and (13-1-4) has a surface roughness of about 0.8 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about three times higher than that of an X-ray waveguide produced by a process not using the planarizing layer. This suggests that the effect of confining an X-ray by the cladding of an X-ray waveguide is enhanced through planarization by a planarizing layer.

### (13-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about 12 times higher than that of an X-ray waveguide produced by a process not using the planarizing layer. This high intensity of waveguided X-rays is believed to be achieved as a result that the X-ray waveguide of this Example can more effectively utilize the regular periodicity of the core by planarization using a planarizing layer and further partial removal of the planarizing layer.

### Example 14

### (14-1) Production of Waveguide

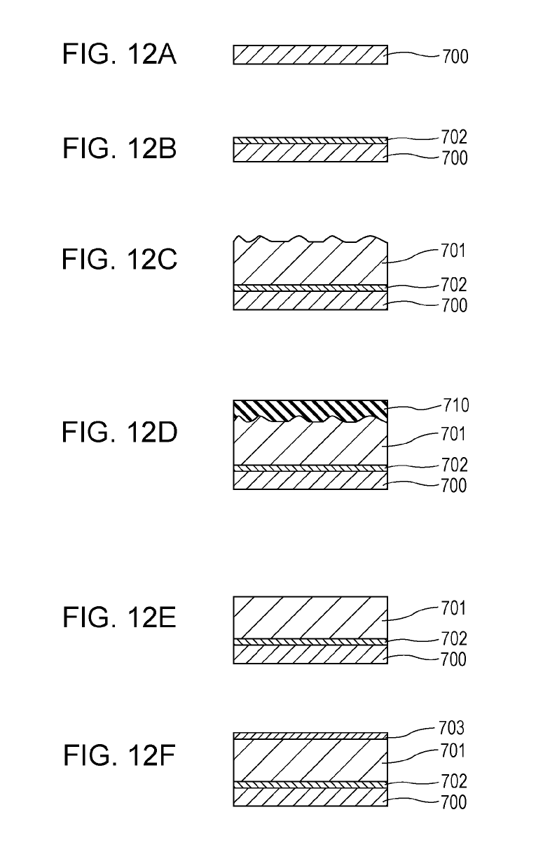

This Example describes an X-ray waveguide having a configuration shown in FIG. 12F where a cladding is formed on the surface of a core through formation of the planarizing layer on one side of the core and removal of the planarizing layer and further part of the core by polishing.

The X-ray waveguide produced in this Example include a cladding 702 of tungsten(W), a core 701, a cladding 703 stacked in this order on a Si substrate 700. The core 701 is a silicon oxide mesostructured film. This mesostructured film has two-dimensionally arranged pores filled with an organic substance and has a periodic structure formed in the film thickness direction. In this Example, the planarizing layer is a silicon oxide film. The process of producing the X-ray waveguide of this Example will be described with reference to FIGS. 12A to 12F.

### (14-1-1) Formation of Cladding (FIG. 12B)

A cladding is formed by the same procedure as in step (10-1-1).

### (14-1-2) Formation of Core (Silicon Oxide Mesostructured Film) (FIG. 12C)

A mesostructured film is formed by the same procedure as in step (10-1-3).

### (14-1-3) Formation of Planarizing Layer (FIG. 12D)

A silicon oxide film is formed by the same procedure as in step (13-1-3).

### (14-1-4) Planarization Treatment

Subsequently, the resulting planarizing layer is polished for further planarization. Polishing is performed by a polishing solution manufactured by Buehler, Ltd., which is a water dispersion of colloidal silica particles having a diameter of 60 nm, using a CMP apparatus (manufactured by MAT Inc.). The planarizing layer is removed in this step by an amount corresponding to a thickness of 250 nm by controlling the polishing time. A cross-section of the resulting substrate is analyzed with a transmission electron microscope (TEM) to confirm that the planarizing layer formed in step (14-1-3) is removed and that the core formed in step (14-1-2) is partially removed by an amount corresponding to a thickness of about 50 nm (this means that polishing progresses to the core layer after removal of the planarizing layer), resulting in planarization of the core surface (FIG. 12E).

### (14-1-5) Formation of Cladding

A cladding 703 of tungsten is formed on the planarized layer by sputtering so as to have a thickness of about 15 nm. The cladding is formed so as to adhere to the surface of the planarized layer, i.e., the core 701.

### (14-2) Relationship Between Surface Roughness and X-Ray Reflectance

The surface roughness is evaluated with a surface roughness tester. The mesostructured film 701 that serves as the core formed in step (14-1-2) has a surface roughness of about 12 nm as the root-mean-square value. The core planarized in steps (14-1-3) and (14-1-4) using the planarizing layer has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about twice higher than that of an X-ray waveguide produced by a process not using the planarizing layer. This suggests that the effect of confining an X-ray by the cladding of an X-ray waveguide is enhanced through planarization treatment using a planarizing layer.

### (14-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about eight times higher than that of an X-ray waveguide produced by a process not using the planarizing layer. This high intensity of waveguided X-rays is believed to be achieved as a result that the X-ray waveguide of the present invention can effectively utilize the regular periodicity of the core through planarization using a planarizing layer and subsequent removal of the planarizing layer.

### Example 15

### (15-1) Production of Waveguide

This Example describes an X-ray waveguide having a configuration where a planarizing layer is formed by the same procedure as in Example 3 except that the planarizing layer has a thickness of 20 nm.

### (15-1-1) Formation of Cladding

A cladding is formed by the same procedure as in step (12-1-1).

### (15-1-2) Formation of Core (Silicon Oxide Mesostructured Film)

A mesostructured film is formed by the same procedure as in step (12-1-3).

### (15-1-3) Formation of Planarizing Layer

A silicon oxide film is formed by the same procedure as in step (12-1-3).

### (15-1-4) Planarization Treatment

Subsequently, the resulting planarizing layer is subjected to reactive ion etching (RIE). RIE is performed using a dry etching apparatus to remove the planarizing layer by an amount corresponding to a thickness of 380 nm and thereby to form a planarizing layer finally having a thickness of 20 nm on the mesostructured film as the core.

### (15-2) Relationship Between Surface Roughness and X-Ray Reflectance

The surface roughness is evaluated with a surface roughness tester. The surface planarized using the planarizing layer in steps (15-1-3) and (15-1-4) has a surface roughness of about 2 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives satisfactory reflectance equivalent to that of the X-ray waveguide produced in Example 3.

(15-3) Wave guiding characteristics

An X-ray of 10 keV is allowed to enter the waveguide, and strength of the X-ray guided by a periodicity-resonant waveguide mode is measured. As a result, the X-ray waveguide gives an intensity of waveguided X-rays about eight times higher than that of an X-ray waveguide produced by a process not using the planarizing layer. This high intensity of waveguided X-rays is believed to be achieved by that in the X-ray waveguide of the present invention, the efficiency of confining an X-ray is increased by planarization by the planarizing layer, and the thickness of the planarizing layer is further optimized than that in Example 3.

### Example 16

### (16-1) Production of Waveguide

This Example describes an X-ray waveguide having a configuration produced by the same procedure as in Example 11 except that the planarizing layer is made of titanium oxide.

### (16-1-1) Formation of Cladding

A cladding is formed by the same procedure as in step (11-1-1).

### (16-1-2) Formation of Core (Silicon Oxide Mesostructured Film)

A mesostructured film is formed by the same procedure as in step (11-1-3).

### (16-1-3) Formation of Planarizing Layer (Titanium Oxide)

A planarizing layer of a titanium oxide is formed by spin coating. A solution of a precursor is prepared by adding acetic acid, 1-propanol, ethanol, and water to titanium tetraisopropoxide and subjecting the mixture to ultrasonication for 15 min. The volume ratios of the used reagents are titanium tetraisopropoxide: 2.5, acetic acid: 5, 1-propanol: 5, ethanol: 15, and water: 1. The solution is appropriately diluted for controlling the film thickness. The solution is applied onto the mesostructured film prepared in the previous step with spin coating equipment to form a film. The film is held in a constant temperature/humidity chamber at 25° C. and a relative humidity of 40% for 24 hr to form a titanium oxide film having a thickness of 15 nm.

### (16-2) Relationship Between Surface Roughness and X-Ray Reflectance

The surface roughness is evaluated with a surface roughness tester. The surface planarized using the planarizing layer in step (16-1-3) has a surface roughness of about 3 nm as the root-mean-square value.

Comparative evaluation of reflectance when the cladding of the X-ray waveguide is irradiated with an X-ray is performed. The X-ray reflectance is measured when an X-ray of 10 keV is incident on the cladding at an angle (θ=0.3°: within the total reflection region of cladding) failing Bragg reflection, but being close to the Bragg angle (θ=0.36°) corresponding to the periodic structure of the core.

The X-ray waveguide of this Example gives an X-ray reflectance about two and half times higher than that of an X-ray waveguide produced by a process not using the planarizing layer.

### (16-3) Wave Guiding Characteristics

An X-ray of 10 keV is allowed to enter the waveguide, and strength of the X-ray guided by a periodicity-resonant waveguide mode is measured. As a result, the X-ray waveguide gives an intensity of waveguided X-rays about four times higher than that of an X-ray waveguide produced by a process not using the planarizing layer. This high intensity of waveguided X-rays is believed to be achieved by that in the X-ray waveguide of this Example, the efficiency of confining an X-ray is increased by planarization by a planarizing layer.

The X-ray waveguide of the present invention can be used in, for example, parts of X-ray optical systems utilizing X-rays for image pickup, exposure, analysis, etc.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-197251 filed Sep. 9, 2011, No. 2011-197252 filed Sep. 9, 2011, and No. 2011-197253 filed Sep. 9, 2011, which are hereby incorporated by reference herein in their entirety.

What is claimed is:

1. An X-ray waveguide for guiding X-rays in a waveguiding direction, comprising:
a core having a periodic structure composed of a plurality of materials each having a different real part of refractive index in a direction perpendicular to the waveguiding direction;
a cladding having a real part of refractive index lower than the real part of refractive index of the core; and
a planarizing layer arranged between the core and the cladding,
wherein the critical angle for total reflection at the interface between the planarizing layer and the cladding is larger than the Bragg angle of the periodic structure of the core.

2. An X-ray waveguide comprising a core and a cladding for guiding X-rays in a waveguiding direction, the X-rays having a wavelength of 1 pm or more and 100 nm or less, wherein:
the core has a periodic structure composed of a plurality of materials each having a different real part of refractive index in the direction perpendicular to the waveguiding direction;
a planarizing layer is arranged between the core and the cladding; and
the critical angle for total reflection at the interface between the planarizing layer and the cladding is larger than the Bragg angle of the periodic structure of the core.

3. The X-ray waveguide according to claim 1, wherein the planarizing layer has an electron density that is equal to or higher than that of the material having the highest electron density among the plurality of materials constituting the periodic structure of the core and is lower than that of the cladding.

4. The X-ray waveguide according to claim 1, wherein the planarizing layer is made of a material having an electron density that is equal to that of the material having the highest electron density among the plurality of materials constituting the periodic structure of the core.

5. The X-ray waveguide according to claim 1, wherein, at the interface between the planarizing layer and the cladding, the planarizing layer has a surface roughness of 5 nm or less as the root-mean-square value.

6. The X-ray waveguide according to claim 1, wherein the planarizing layer is made of an oxide containing any one selected from the group consisting of Si, Al, Ti, Zn, Nb, Zr, and Sn.

7. The X-ray waveguide according to claim 1, wherein the core is made of a mesostructured material.

8. An X-ray waveguide for guiding X-rays in a waveguiding direction, comprising:
a core having a periodic structure composed of a plurality of materials each having a different real part of refractive index in the direction perpendicular to the waveguiding direction;
a cladding having a real part of refractive index lower than that of the core; and
a planarizing layer arranged between the core and the cladding,
wherein the core and the planarizing layer are in contact with the cladding; and
the critical angles for total reflection at the interface between the cladding and the planarizing layer and at the interface between the cladding and the core are larger than the Bragg angle of the periodic structure of the core.

9. The X-ray waveguide according to claim 8, wherein a ratio of a surface area of the cladding being in contact with the core to a total surface area of the cladding being in contact with the planarizing layer and the core is 30% or more and 95% or less.

10. The X-ray waveguide according to claim 8, wherein the ratio of the surface area of the cladding being in contact with the core to the total surface area of the cladding being in contact with the planarizing layer and the core is 60% or more and 95% or less.

11. The X-ray waveguide according to claim 8, wherein the core and the planarizing layer are made of the same material.

12. An X-ray guiding system comprising:
an X-ray waveguide for guiding X-rays in a waveguiding direction, the X-ray waveguide including a core, a cladding, and a planarizing layer arranged between the core and the cladding; and
an X-ray source emitting the X-rays having a wavelength of 1 pm or more and 100 nm or less such that the X-rays are incident on the X-ray waveguide,
wherein the core has a periodic structure composed of a plurality of materials each having a different real part of refractive index in the direction perpendicular to the waveguiding direction; and
the critical angle for total reflection of the incident X-rays at the interface between the planarizing layer and the cladding are larger than the Bragg angle of the periodic structure of the core.

13. The X-ray guiding system according to claim 12, wherein the core and the planarizing layer are in contact with the cladding, and the critical angle for total reflection of the incident X-rays at the interface between the planarizing layer and the cladding is larger than the Bragg angle of the periodic structure of the core.

14. A process of producing an X-ray waveguide, comprising:
forming a planarizing layer on a surface of a core having a periodic structure composed of a plurality of materials having different real part of refractive index in the direction perpendicular to the X-ray-guiding direction; and
forming a cladding on the planarizing layer.

15. The process of producing an X-ray waveguide according to claim 14, the process further comprising planarizing the planarizing layer.

16. The process of producing an X-ray waveguide according to claim 14, wherein the critical angle for total reflection for the X-ray at the interface between the planarizing layer and the cladding is larger than the Bragg angle resulted from the periodicity of the core.

17. The process of producing an X-ray waveguide according to claim 14, wherein the planarizing layer at the interface between the planarizing layer and the cladding has a surface roughness of 5 nm or less as the root-mean-square value.

18. The process of producing an X-ray waveguide according to claim 14, wherein the planarizing layer is composed of the same material as the core.

19. The process of producing an X-ray waveguide according to claim 14, wherein the planarizing layer is formed so as to have a thickness of 3 nm or more and 100 nm or less.

20. The process of producing an X-ray waveguide according to claim 14, the process further comprising planarizing the planarizing layer and planarizing the core.
